(19) United States
(12) Patent Application Publication
(10) Pub. No.: US 2021/0156729 A1
(43) Pub. Date: May 27, 2021

(54) ONBOARD LOAD SENSOR FOR USE IN FREIGHT RAILCAR APPLICATIONS

(71) Applicant: The Board of Regents of The University of Texas System, Austin, TX (US)

(72) Inventors: Constantine Tarawneh, Edinburg, TX (US); Stephen Crown, Edinburg, TX (US)

(21) Appl. No.: 17/097,889

(22) Filed: Nov. 13, 2020

Related U.S. Application Data
(60) Provisional application No. 62/934,600, filed on Nov. 13, 2019.

(51) Int. Cl. G01G 19/12; G01G 19/04; B61F 5/32; B61F 5/36

(52) U.S. Cl. CPC G01G 19/12; B61F 5/36; B61F 5/32; G01G 19/047

(57) ABSTRACT

Described herein is a load sensor for a railcar that includes one or more strain gauges and one or more temperature sensors. The load sensor has a size and configuration that allows the load sensor to be embedded in a bearing adapter under the polymer steering pad of the railcar.

### STATEMENT REGARDING FEDERALLY SPONSORED RESEARCH OR DEVELOPMENT

This invention was made with government support under Grant No. DTRT 13-G-UTC59 awarded by U.S. Department of Transportation. The government has certain rights in the invention.

### BACKGROUND OF THE INVENTION

### 1. Field of the Invention

The invention generally relates to a sensor used to measure the load of freight railcars.

### 2. Description of the Relevant Art

Approximately 40% of intercity freight transportation occurs by rail, making it the most widely used method of transporting large commodities. This trend is expected to persist over the next thirty years as our highway systems are strained and experiencing increased congestion and costly delays. In fact, accounting for weight and distance, rail is the most prominent method of intercity freight transportation, leading transportation by truck by 10.9% in 2010. Freight transportation is described as arguably “the safest, most efficient, and cost effective” method in the world by the Federal Railroad Administration.

An important component of railcar freight transportation is the ability to frequently and accurately weigh the amount of product being shipped in a railcar. The most common way to accomplish this is to weigh the entire railcar. Using the known weight of the empty railcar, the weight of the product can be determined. This method, while generally accurate, is cumbersome and time consuming. In order to weigh an entire railcar, the railcar is moved to a scale, which requires the use of railyard transportation. In a busy railyard, it can be difficult to quickly move a railcar for weighing. This becomes more of an issue during the railcar loading process. During a loading process the railcar may need to be moved away from the loading chute to the scale as many as five times to insure the optimal fill.

It is also useful to be able to know the weight of the product in the railcar while the product is in transit. At various stops along the route it would be particularly useful for the shipper to know that the weight of the product has not changed. Weighing of the railcar during transit can be done by moving the railcar to a scale. As noted above, however, this can be time consuming. Furthermore, once transit of the product has begun, weighing of the material may not be possible because of the transportation schedule.

It is therefore desirable to have the ability to determine the weight of the product in a railcar at any time, without the need to move the railcar to a scale. Having this ability would allow the shipper to frequently and accurately know the amount of product that is being shipped.

### SUMMARY OF THE INVENTION

In an embodiment, a load sensor device for a railcar includes: a casing; one or more strain gauges and one or more temperature sensors disposed in the casing; and a processor coupled to the one or more strain gauges and the one or more temperature sensors, wherein the processor collects data obtained by the one or more strain gauges and the one or more temperature sensors. The casing has a shape and size configured to be embedded in a bearing adapter of the railcar.

At least one of the one or more strain gauges is capable of measuring an applied load of between about 10 kN to about 200 kN. At least one of the one or more temperature sensors is capable of measuring temperatures ranging from about −40° C. to about 150° C. In an embodiment, openings are formed in the casing at the position of each of the one or more temperature sensors.

The load sensor device may include a line driver coupled to the one or more strain gauges and the one or more temperature sensors. The line driver is configured to amplify the data obtained from the one or more strain sensors and the one or more temperature sensors.

In an embodiment, a system for determining the mass of a railcar includes: one or more load sensor device(s) positioned on a bearing adapter of a railcar and a control box. In one embodiment, the load sensor device is placed on a top surface of the bearing adapter. The control box is positioned inside the railcar. The control box is coupled to the one or more load sensor devices. The control box may include a signal conditioner.

The control box is coupled to the one or more load sensors. In an embodiment, the control box is coupled to the one or more load sensors through a wireless connection, although wired connections can also be used.

The control box may include one or more processors configured to perform signal conditioning of signals received from the load sensor device.

In one embodiment, a bearing adapter for a railcar, the bearing adapter having a body having a substantially planar top surface, an arced bottom surface, and sidewalls connecting the top surface to the bottom surface. The top surface receives a portion of a railcar side frame during use. The arced bottom surface rests on a portion of a bearing assembly during use.

A load sensor device is at least partially embedded in a surface of the body. In one embodiment, the load sensor device is embedded in a top surface of the body. In one embodiment, the casing extends above the top surface of the body. The casing extends no more than 0.5 mm above the top surface of the body.

In an embodiment, a method of determining the mass of a railcar includes obtaining a bearing adapter. A load sensor device is at least partially embedded in a surface of the body. The mass of the railcar is determined by (1) measuring a change in strain during filling of the railcar with one or more of the strain gauges and (2) measuring the temperature of the bearing adapter with one or more of the temperature gauges; and (3) determining the change in mass of the railcar using the change in strain and the measured temperature of the bearing adapter. The mass of the railcar is a function of the change in strain and the measured temperature of the bearing adapter.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a projection view of a bearing adapter;

FIG. 2 depicts a single bearing test rig;

FIG. 3 depicts the loading setup for a four-bearing test axle;

FIG. 4 depicts a schematic diagram of the resistor of a strain gauge;

FIG. 5 depicts a flex circuit having a circuit board coupled to a flexible sensor strip;

FIG. 6 depicts a steel bearing adapter modified to accept a load sensor device;

FIG. 7 depicts a top view of the casing of a load sensor device;

FIG. 8 depicts a bottom view of the casing of a load sensor device;

FIG. 9 depicts a load sensor circuit;

FIG. 10 depicts a temperature circuit;

FIG. 11 depicts an amplifier circuit;

FIG. 12 depicts the results of a calibration study;

FIG. 13 depicts a schematic diagram of a second-order calibration scheme for a single load sensor device;

FIG. 14 depicts a schematic diagram of a multivariate correlation scheme for a single load sensor device;

FIG. 15 depicts actual load vs. determined load data generated during axle rotation using a second-order calibration scheme;

FIG. 16 depicts actual load vs. determined load data generated during axle rotation using a multivariate correlation scheme;

FIG. 17 depicts actual load vs. determined load data generated during static testing using a second-order calibration scheme;

FIG. 18 depicts actual load vs. determined load data generated during static testing using a multivariate correlation scheme;

FIG. 19 depicts a schematic diagram of a multivariate correlation scheme for multiple load sensor devices;

FIG. 20 depicts determined load data at various ramping rates using a multivariate correlation scheme;

FIG. 21 depicts determined load data at various temperatures, at a 2-minute ramp rate using a multivariate correlation scheme;

FIG. 22 depicts determined load data at various temperatures, with axle rotation at 53 km/h;

FIG. 23 depicts determined load data at various temperatures, with axle rotation at 106 km/h;

FIG. 24 depicts data collected during a cyclic loading and unloading test;

FIG. 25 depicts error calculations at different loading rates;

FIG. 26 shows a detailed view of a portion of the data collected in FIG. 25;

FIG. 27 depicts error calculations at slower loading rates;

FIG. 28 shows a detailed view of a portion of the data collected in FIG. 27;

FIG. 29 depicts data collected during a strain-gauge controlled ramping experiment;

FIG. 30 depicts a detailed view of the upper portion of the data presented in FIG. 29;

FIG. 31 depicts a side view of an impact testing device;

FIG. 32 depicts data for load measurement and impact forces determined during impact testing;

FIG. 33 depicts data collected to determine the life threshold stress;

FIG. 34 depicts data collected during a cyclic loading and unloading test with axel rotation;

FIG. 35 depicts actual load vs. determined load data generated with axle rotation using a second-order calibration scheme at loads above 90% of full load during the first week of testing;

FIG. 36 depicts actual load vs. determined load data generated with axle rotation using a multivariate correlation scheme at loads above 90% of full load during the first week of testing;

FIG. 37 depicts actual load vs. determined load data generated with axle rotation using a second-order calibration scheme at loads above 90% of full load during the second week of testing;

FIG. 38 depicts actual load vs. determined load data generated during axle rotation using a multivariate correlation scheme at loads above 90% of full load during the second week of testing;

FIG. 39 depicts actual load vs. determined load data generated with axle rotation using a second-order calibration scheme at loads above 90% of full load during the third week of testing;

FIG. 40 depicts actual load vs. determined load data generated during axle rotation using a multivariate correlation scheme at loads above 90% of full load during the third week of testing;

FIG. 41 depicts an overview of load data collected using a spalled bearing;

FIG. 42 depicts load data collected with a spalled bearing using a second-order calibration scheme during the first week of testing;

FIG. 43 depicts load data collected with a spalled bearing using a multivariate correlation scheme during the first week of testing;

FIG. 44 depicts load data collected with a spalled bearing using a second-order calibration scheme during the second week of testing;

FIG. 45 depicts load data collected with a spalled bearing using a multivariate correlation scheme during the second week of testing;

FIG. 46 depicts an overview of load data collected using a spalled bearing at loads above 90% of full load;

FIG. 47 depicts load data collected with a spalled bearing at loads above 90% of full load using a second-order calibration scheme during the first week of testing;

FIG. 48 depicts load data collected with a spalled bearing at loads above 90% of full load using a multivariate correlation scheme during the first week of testing;

FIG. 49 depicts load data collected with a spalled bearing at loads above 90% of full load using a second-order calibration scheme during the second week of testing; and

FIG. 50 depicts load data collected with a spalled bearing at loads above 90% of full load using a multivariate correlation scheme during the second week of testing.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The examples set forth herein are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Embodiments described herein are directed to the implementation of a load-sensing insert embedded within an bearing adapter that incorporates both a second-order model and a multivariate regression model to compare the measured output of the sensor with the actual load applied to the bearing during operation. The load sensor-insert may also incorporate one or more temperature sensors that have the capability to capture the operating temperature of the inboard and outboard raceways of the bearing, allowing for temperature to factor into the load calculation. The load sensor-insert incorporates two bearing health-assessment measures, providing for a reliable, onboard freight railcar load and temperature condition monitoring system that can be readily implemented with minor modifications to current bearing-adapter assemblies.

The current methods of load measurement typically involve the use of weighbridges. While railcars drive through a “rail-yard” or a specified section of track, companies will use computerized systems to determine the car weight via large capacity load cells. Most weighbridges stipulate that the car either stop or travel at extremely low speeds, approximately ten kilometers per hour (six miles per hour). In many cases, for the most accurate measurement, the cars will be uncoupled and weighed separately. Therefore, not only are the rail companies charged for this service, but a large portion of profit is lost in travel time. A database stores the load information received from the weighbridge. If the train is overloaded, the company pays a fine to ensure that future railcars will transport the appropriate weight, providing safety to the track, suspension elements, and wheels. Unfortunately, weighbridges are uncommon, which limits their impact on the industry.

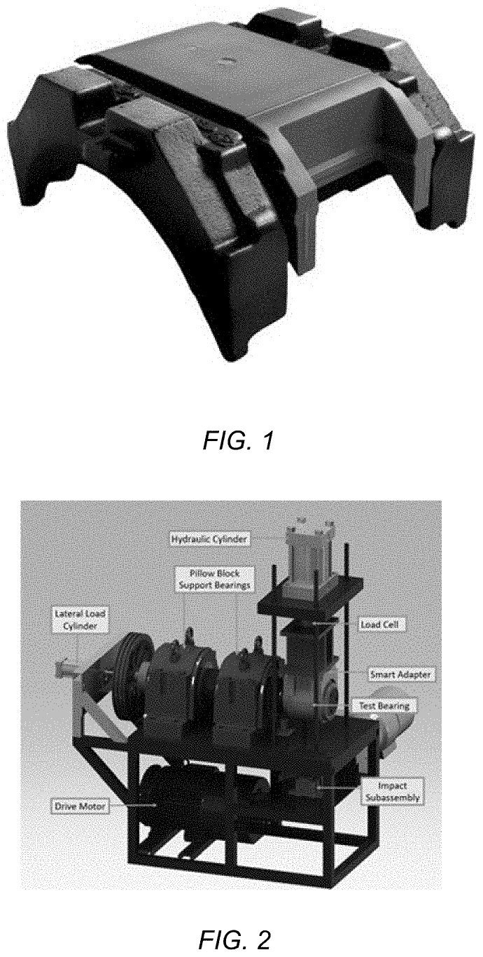

The successful implementation of a load sensor device depends, in part, on the strategic placement of the load sensor device within the bearing adapter. For the most accurate measurements, the load sensor device placement should be directly in the path of the applied load. In an embodiment, the load sensor device is applied directly above the bearing adapter. A polymer adapter pad is positioned on top of the bearing adapter between the bearing adapter and the side frame of the railcar. The bearing adapter sits on top of the railcar bearing assembly, which is positioned at the end of the wheelset. By placing a load sensor device on the top surface of a bearing adapter, directly between the polymer adapter pad and the steel bearing adapter, the load sensor device can accurately detect the portion of the load seen by the bearing assembly. A typical adapter pad/bearing adapter assembly is depicted in FIG. 1.

The design qualifications require that the load sensor device survive and monitor loads ranging from 10 kN to 200 kN, which are the estimated unloaded (empty) and fully-loaded weights, respectively, on each bearing assembly of a class F and K railcar (the total weight of a railcar can be calculated by multiplying these values by eight). Moreover, the load sensor device would need to transmit a reliable signal over the wide range of load unaffected by the impact forces that are generated by typical service operation, and by abnormal operation resulting from bearings with spalls and defects, impacts due to wheel flats, or bad segments of track.

The temperature sensors incorporated into the load sensor device need to detect extreme bearing assembly operating temperatures, i.e., −40° C. to 150° C. (−40° F. to 300° F.). The temperatures around the circumference of the bearing assembly vary. However, the highest temperatures are usually recorded at the region of load application, which is the area at the top of the bearing assembly right under the bearing adapter. To provide an accurate estimate of the highest temperature region of the bearing assembly, the temperature sensors should be located at the top of the bearing adapter, right below the region of applied load, and near the centers of the inboard and outboard raceway portions of the bearing cup (outer ring) of the bearing assembly.

A Single-Bearing Test Rig, depicted in FIG. 2, was used to carry out the series of experiments for constant load correlations. The test rig can closely mimic field service operation and can simulate numerous normal and abnormal load conditions a railroad bearing might experience in the field, making it favorable for laboratory-controlled experimental testing. The single-bearing test rig allows for both static and dynamic testing with speeds varying from 8 to 137 km/h (5 to 85 mph) under loads ranging from 10-120% of full-load; full-load being 153 kN (34.4 kips, 15.3 tons) per bearing.

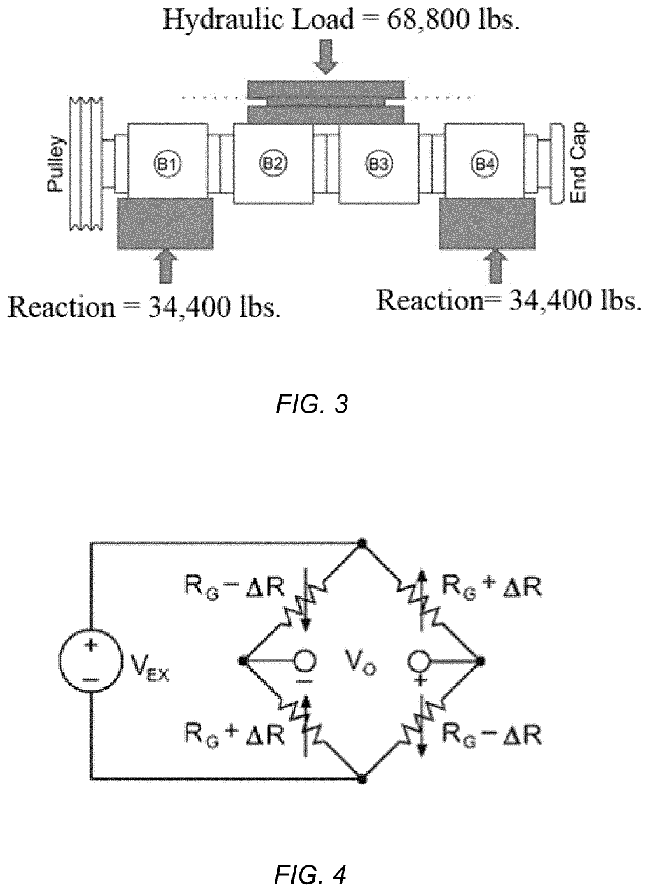

A test rig was housed within an environmental chamber to generate a supplementary ramping calibration at several operating temperatures. FIG. 3 illustrates the loading setup for a four-bearing test axle. A four-bearing test rig has similar capabilities to those of the single bearing tester in terms of static and dynamic load application, but it provides the additional temperature parameter that is needed to validate the results acquired from the multivariate calibration. The environmental chamber is equipped with an industrial-strength air-conditioning unit and fans that control the ambient temperature, allowing the testing environment to range from −40° C. to 55° C. (−40° F. to 131° F.).

The motors used in both test rigs are 22 kW (30 hp) motors that are controlled using variable frequency drives (VFDs) that accurately maintain the desired angular speeds to within 0.5%. The VFDs can output the angular speed and the motor power simultaneously. The latter data is collected for every experiment to check for any abnormal operation during testing.

The test rigs used in all experiments utilize a hydraulic cylinder for load application. To counter the effects of thermal expansion of the oil within the hydraulic cylinders, an external load controller device was fabricated and used. The load controller apparatus is an additional, reactionary, 38 mm (1½-inch) bore hydraulic cylinder driven by a linear actuator, which transforms the rotational movement of a DC motor to translational movement through a threaded rod via a gearbox. A computer equipped with a DAQ (data acquisition) device and the software LabVIEW™ provides the ability to run extremely detailed testing plans.

An error loop in the program reads the force defined by the load cell voltage. It then regulates the load the hydraulic cylinder applies and determines whether to increase or decrease the pressure. If the error exceeds a pre-programmed value, the analog output in the port of a NI USB-6211 DAQ sends a five-volt pulse signal to the motor controller until the force applied is within the specified tolerance.

The load controller can provide a steady, accurate load at a resolution of ±445 N (100 lbf); however, when conducting dynamic testing, the impact forces generated by the rotation of the axle can fluctuate the load significantly, well above the ±445 N range. For the most part, these fluctuations are due to geometric raceway tolerances. Nonetheless, an error range of ±1,560 N (350 lbf) was utilized for the experimental testing. The system can additionally execute programmed test plans that simulate loading cycles at varying rates for prolonged periods of time. Although, the device can function independent of human supervision, for simulation purposes, the axle rotation was physically stopped when loading or unloading the bearing to accurately mimic actual loading/unloading scenarios in field service.

For both test rigs, a computer with a National Instruments™ cDAQ-9474 USB chassis coupled with a NI 9205, 32 channel, ±10 Volt analog input module collected the data for the experiments at a sampling rate of 50 Hz. The information was then post-processed in MATLAB™ with a moving average of 200 data points corresponding to four seconds of averaged data. The decision for this specific averaging window is intentional. The averaging allowed for the alignment of the load sensor data with currently used accelerometers affixed to the two test rigs. In future testing, the load and temperature data acquired from the load sensor insert coupled with the vibration sensor data could provide a comprehensive onboard condition-monitoring technology.

The strain gauge used in load sensor device is manufactured by Micro Measurements™. It is a full-bridge, transducer class device with a 350-Ohm nominal resistance. Four resistors make-up the full-bridge strain gauge. A schematic diagram of the resistor is depicted in FIG. 4. The device is adhered to a surface, and when the surface of the material strains, it alters the resistance of the circuit. The transducer holds two active resistors considered “axial” gauges. These resistors measure the strain experienced in the bending direction of the sensor. The remaining two eliminate changes that occur due to thermal expansion of the wiring. They are termed “temperature compensation” resistors or “transverse” gauges and are oriented with the neutral or non-bending axis of the sensor insert. Temperature compensation works by subtracting the voltage potential change due to temperature shifts in the transverse gauges from the output of the active gauges. Therefore, a full-bridge transducer strain gauge only detects changes caused by deformation.

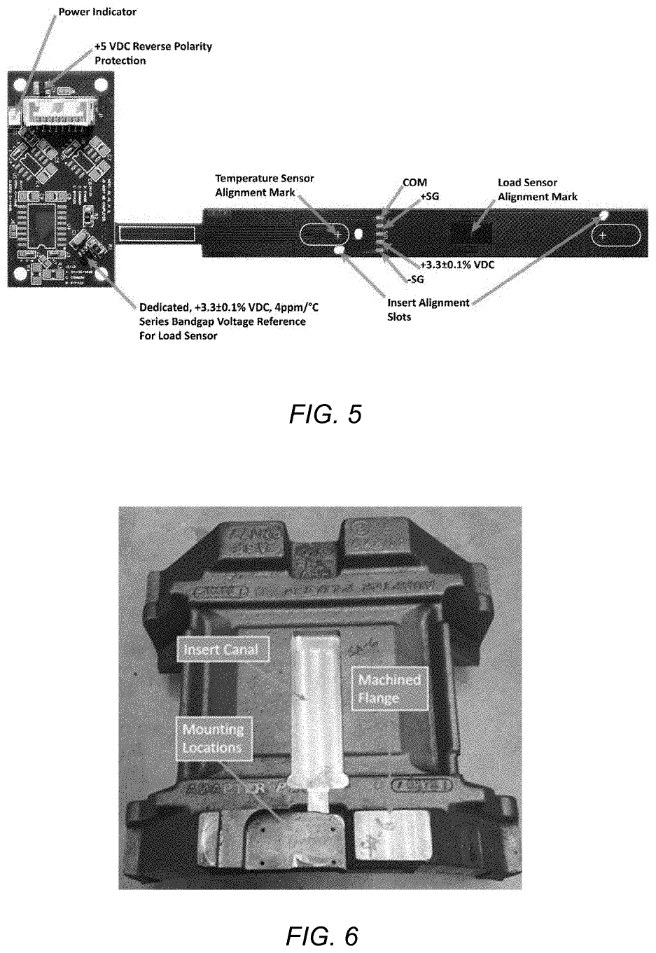

Additionally, a specially designed flex circuit was utilized to provide wiring to the load insert. FIG. 5 depicts a flex circuit having a circuit board coupled to a flexible sensor strip. The insert design created numerous constraints that made the flex circuit a suitable choice improving functionality and reliability because of its ultra-thin design. The flexible sheet also provides a secure location for the two analog, surface-mount temperature sensors without the need for additional wires.

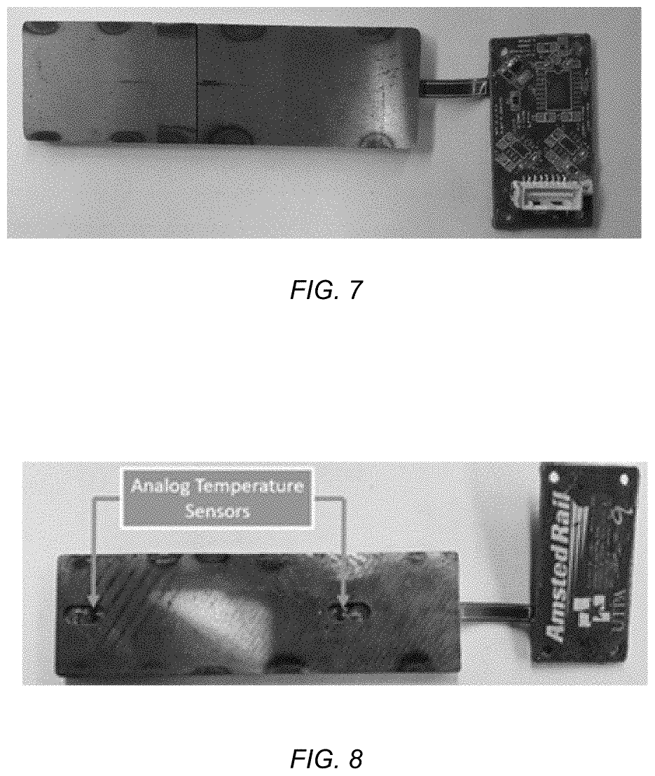

The flex circuit is embedded in a metal casing to from a load sensor device. FIG. 7 depicts a top view of the load sensor device. FIG. 8 depicts a bottom view of the load sensor device. The metal casing is made from a top component and a bottom component that are connected to each other (e.g., by welding). Once the top and bottom components are machined, the load sensor device can be assembled. The flex circuit is aligned with machined dowel pins in the lower component and adhered in place. The strain gauge, mounted on the upper component, is soldered to the flex circuit, and the entire assembly can then be welded together. In order to weld the upper and lower components, an aluminum heat sink is needed to ensure that the heat from the welding process does not damage the flex circuit or sensors housed in the insert. Great care was taken to ensure that when constructing each sensor, the strain gauge was placed with a similar orientation, so as to limit the human error involved in future results. Despite the cautionary assembly, different voltages are output by the sensors under similar loading conditions. Temperature sensors are placed in slots that are machined to place the temperature sensor as near to the bearing adapter surface as possible (See FIG. 8). Despite its thin appearance, the flex circuit should have some clearance to avoid both damage to the strain gauge and uncertainty in the results. In some embodiments it was noted that if enough clearance is not provided, the sensor may display random errors in the measured load.

The steel bearing adapter had to undergo a series of machining processes to implement the necessary features for the load sensor device, as shown in FIG. 6. A canal was machined where the load sensor device would be placed, and mounting locations were machined for the circuitry port of the sensor. The length of the load sensor device, in some embodiments, ranges from 4 to 5 inches (100-127 mm). Keeping the length of the load sensor device to these lengths resulted in reduced machining time that is necessary to alter the bearing adapter for inclusion of the load sensor device by effectively shortening the length of the sensor canal.

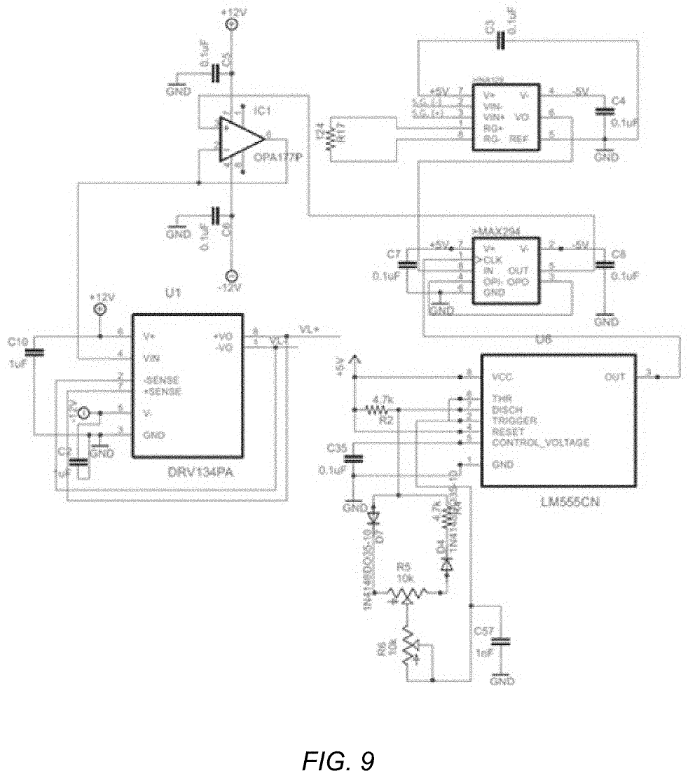

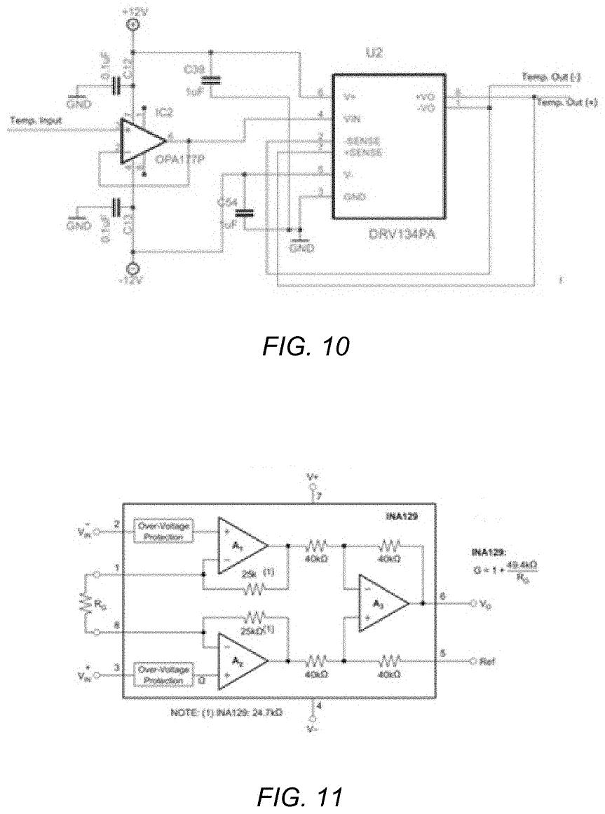

In embodiments when eight load-sensors are installed on one freight railcar a control box was designed that had the capability to carry out signal condition (e.g., load amplification) necessary for four sensors. Therefore, two control boxes would be used for a single railcar: one in the front compartment of the railcar and one in the back compartment, which would consequently ensure that eight load signals and sixteen analog temperature signals would be recorded simultaneously during the testing period. Each control box is coupled to up to four load sensor devices. The control box may be coupled to the load sensors using a wired or wireless (e.g., Bluetooth) connection. In an alternate embodiment, a load-sensor circuitry includes one load signal, two analog temperature signals, and one accelerometer signal. This alternate embodiment eliminated unnecessary components and optimized the board size necessary for the circuitry. Exemplary load and temperature circuits are depicted in FIGS. 9 and 10, respectively.

The output voltage of the strain gauge is on the order of millivolts. To generate a suitable signal in the range of 3-10 V, it was necessary to amplify the very small output of the strain gauge. For the past and current designs of the circuitry box, an INA 129 instrumentation amplifier produced by Texas Instruments (FIG. 11) was integrated into the signal conditioning box design. This component is a low power, yet high accuracy amplifier that harbors adjustable gain by means of a single resistor and has the capability to reach a maximum gain of 600.

The testing environment in which the sensor is deployed is vulnerable to noise from the variable frequency drive which controls the motor rotation of the test rig. After the amplification of the output of the sensor, this noise must be filtered from the signal. The MAX 294 8th order, low pass filter designed by Maxim Integrated Products Inc. was used to filter out the electronic noise on both signal conditioning boards and consequently removed any 60 Hz interference in the signal that is produced as a result of the testing environment.

The adjustable cutoff frequency of the filter can be set by one of two ways. The first involves placing a capacitor of a designated value on the corresponding pin signified by the datasheet of the filter. The second is by applying a clock frequency to the clock pin of the amplifier. The primary benefit of using the capacitor method to set the cutoff frequency lies in simplicity of switching one component, however, this will detrimentally lock the cutoff frequency at a set value. By utilizing a clock frequency produced by a microcontroller, the cutoff frequency can be altered easily by reprogramming the microcontroller. For the purposes of laboratory testing, however, a cutoff frequency of 60 Hz is optimal and the capacitor method is suitable, despite its permanency. In some embodiments, an external oscillator was used to filter the signal. A ‘555’ timer creates a pulse waveform and is controlled by a potentiometer, which allows alteration of the cutoff frequency.

The signal output of the circuitry, in some embodiments, is sent to the instrumentation car, which is typically located ahead of the freight car. A typical railcar is over 60 feet long, therefore, the signal conditioning box must ensure that the output of the sensor can be transmitted through a maximum of 80 feet of cable to the data acquisition system located within the instrumentation car. The primary function of the line driver is to improve the strength of the signal throughout the length of the cable in an effort to discourage voltage drops typical of signals traveling through long lengths of cable. The DRV 134 line driver produced by Texas Instruments™ was selected as the best choice for circuit integration, which is a differential output amplifier that converts a single-ended input to a balanced output pair. Because the line driver requires a high current signal to the integrated circuit, an operational amplifier, OPA 177 from Texas Instruments™, was used to buffer the voltage to provide the required current.

It was discovered that simple inconsistencies in the board resulted in a difference in the output voltage from the signal conditioning processors of the box controller. When analyzing the data to devise a correlation, it was found that there was a difference in the “fully-loaded” reading of the strain gauge, where the output voltage differed by approximately 0.3 V. This error would consequently affect the final product if different signal conditioning boards were used in calibration and implementation. If each board represented a different unknown offset, the integrity of the final product would be diminished. Therefore, in some embodiments, the inherent offset of a signal conditioning box is tested and compensated for before implementation of the load-sensor.

The adapter pad is an injection molded thermoplastic polyurethane (TPU) product produced by Steinmetz, Inc. The pad is an important part of the assembly because it prevents metal-to-metal contact, promotes more efficient steering, and can survive high-operating temperature conditions. The adapter pad is classified as a viscoelastic material and will exhibit creep under a constant load as well as relaxation when the weight is removed. Creep is the tendency of a material to flow, or deform, under an applied force. For this application, the adapter pad is what allows the insert to deform under the weight of the railcar. Unfortunately, because the material flows away from the point of load application, it results in a change of pressure distribution over time. Since the elastomer polymer pad used in the adapter is a viscoelastic material, an accurate correlation relating strain gauge readings to load must also incorporate temperature and strain rates to account for the creep behavior. To further explain, although the full-transducer strain gauge compensates for thermal effects within its circuitry, the temperature-dependent creep of the polymer pad has a measurable effect on the sensor output. This thermal effect must be properly defined and incorporated into the system analysis.

In studies performed to investigate creep of the pad, the results showed that at 50% of full-load of a railcar, the majority of the force is carried by the interlocking ridges of the steering pad. Furthermore, testing revealed that for unloaded conditions, a minimal force is seen in the center of the adapter pad, where the load sensor device is located, and at 100% of full-load, the interlocks still carry the majority of the load, however, a portion of the force is distributed over the center. To reduce creep induced changes to the pad, a shim may be placed under the load insert to raise it above the machined bearing adapter surface. The use of shims effectively reduced the creep problem and produced more accurate results. Different shim heights were tested to find the optimum height of the load sensor device with respect to the machined surface. From these tests, a sensor height of approximately 12 one-thousandths of an inch (0.305 mm) above the adapter surface was found to be the optimal height.

Without integrating a proper calibration into the methodology of the load sensor device, the overall functionality would be diminished. This calibration transforms the voltage output from the signal conditioning in the control box into a measurable force output. To devise a second-order calibration, several iterations of known load conditions are placed upon the adapter assembly and the voltage output is measured. This data is recorded at a known sampling rate and a correlation is formed between the two. A multivariate correlation follows this same process but adds a regression method which defines the relationship between the voltage and temperature data.

Depending upon the desired conditions of the load sensor device employment, a calibration plan can be devised to properly suit its intended use. Both a second order and a multivariate correlation are used in conjunction for dynamic and static testing to compare and find suitable applications for each. For example, to achieve the highest accuracy for fully loaded tanker cars in an effort to detect leaks, a simple calibration with five temperature scenarios occurring at 95%, 100%, and 105% of full load can be utilized. A system interface could additionally be designed which allows the train operator to select a proper correlation for a specific period of time. For example, when the train is being loaded, the “ramping” correlation could be selected, and when the train is traveling long distances, the “multivariate fully-loaded” correlation could be selected. In one embodiment, a calibration was devised which would skew towards higher accuracies for loaded railcars whilst retaining a suitable amount of accuracy for unloaded railcars. Steps at 17% (unloaded simulation), 80%, 95%, and 100% were utilized for dynamic testing purposes, while static testing conditions use steps at 17%, 80%, and 100%.

In a preferred embodiment, before any calibration is performed, the adapter pad should be allowed a settling time. The pad is allowed to creep under the weight of the railcar, simulated by the hydraulic cylinder, before calibration. To this end, the test rigs are loaded up to the proportional full weight of a railcar (34,400 lbf or 153 kN) and run at 40 km/h (25 mph) for at least 24 hours before testing. This process allows the elastomeric material of the adapter pad to conform to its “loaded equilibrium” that lasts throughout the usage of the bearing assembly.

As used herein the phrase “dynamic testing” refers to experiments with active rolling elements, in other words, the test axle is rotating at a prescribed rotational speed during the experiment. Dynamic experiments mimic the service environment of a moving freight railcar with impact forces generated by the vibrations within the bearing assembly. Alternately, the phrase “static testing” refers to testing while there is no rotation of the axle.

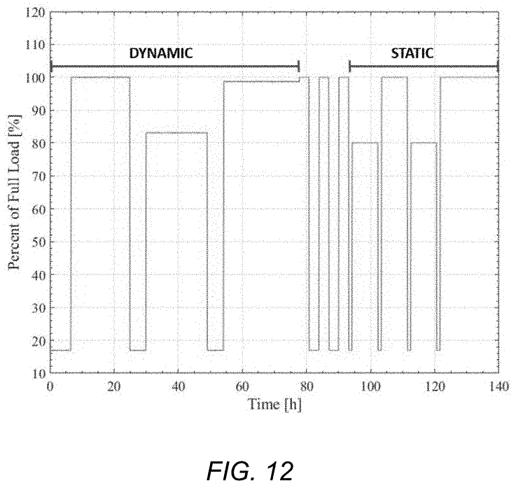

The first experiment, plotted in FIG. 12, was designed to devise a calibration for a fully loaded railcar (34.4 kips or 153 kN per bearing) whilst maintaining accuracy during unloaded (empty railcar) conditions. The test was run at a laboratory temperature of 25° C. on the single bearing test rig pictured in FIG. 2. The experiment entailed three eighteen-hour loaded segments of dynamic testing separated by six-hour unloaded periods (5.85 kips or 26 kN per bearing). The latter was followed by static testing that consisted of several eight-hour constant load segments separated by one-hour unloaded periods, as shown in FIG. 12.

The second set of experiments were carried out utilizing the four-bearing test rig, which is housed in the environmental chamber, and they incorporated temperature and ramping effects into an optimized calibration. Again, all testing was conducted after allowing for the 24-hour “settling time” described earlier. The system started with a loading of 52 kN (11.7 kips), which is equivalent to an unloaded railcar, and ramped up to 306 kN (68.8 kips), which is the load equivalent to a fully loaded wagon. Note that these values are doubled since the hydraulic cylinder on the four-bearing test rig applies load on the two middle bearings simultaneously. The experiments encompassed static ramping tests of 1.5, 2, 3, 5, and 7 minutes that were carried out at different ambient temperatures of −10, 0, 10, 20, 35, and 50° C. Once full load, as indicated by the load cell, was reached, the hydraulic system load controller maintained the load according to the sensor for approximately 120 seconds. Additionally, dynamic two-minute ramp experiments, at speeds of 53 and 106 km/h (33 and 66 mph), were performed at the various temperature conditions stated earlier.

To make the load sensor insert an integral part of any condition-monitoring system, a proper calibration should be integrated. Multivariate calibration provided the basis for a fully calibrated load sensor system. By evaluating constant load and ramping conditions, the final multivariate calibration was developed and validated.

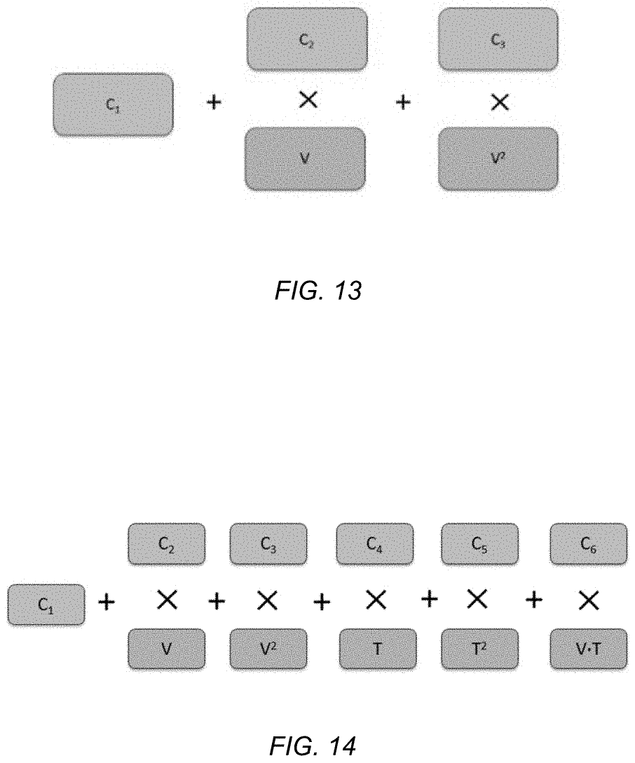

For the constant load calibration, two correlation methods were compared on the single bearing test rig. The first method was a second-order calibration with the scheme shown in FIG. 13. The second method was a multivariate correlation, shown in FIG. 14, which includes a regression algorithm that incorporates temperature information to define the relationship between the strain-gauge conditioned signal and the applied force as measured by the load cell (reference value). In both figures, C=Constant Coefficients, V=Load Voltage, and T=Temperature. A multivariate correlation defines the relationship between the parameter data collected in an experiment to optimize the accuracy and precision of a certain prototype or device.

To devise both calibration methods, several iterations of known load conditions were run, after the allotted 24-hour “settling time”. The voltage output from the signal conditioning box was measured. Once data were recorded both from the load cell and the signal conditioning box via the data acquisition system, a MATLAB™ script was run to correlate all the acquired information.

The full dynamic and static portions of testing were used to obtain the coefficients listed in Table 1 and Table 2. The second-order correlation utilizes three coefficients; namely, an offset, and two values related to the voltage output of the sensor with units of volts and square volts. In contrast, the multivariate correlation has six coefficients; namely, an offset, two voltage-dependent coefficients, two temperature-dependent coefficients, and one pairing of the two parameters.

TABLE 1
Second-order correlation coefficients
Second-Order Correlation

| C₁ | C₂ | C₃ |
|---|---|---|
| [V₀] | [V] | [V²] |
| −23490 | 7157 | 344 |

TABLE 2
Multivariate correlation coefficients
Multivariate Correlation

| C₁ | C₂ | C₃ | C₄ | C₅ | C₆ |
|---|---|---|---|---|---|
| [V₀] | [V] | [V²] | [T] | [T²] | [V · T] |
| −53972 | 15165 | −197 | 856 | −6 | −123 |

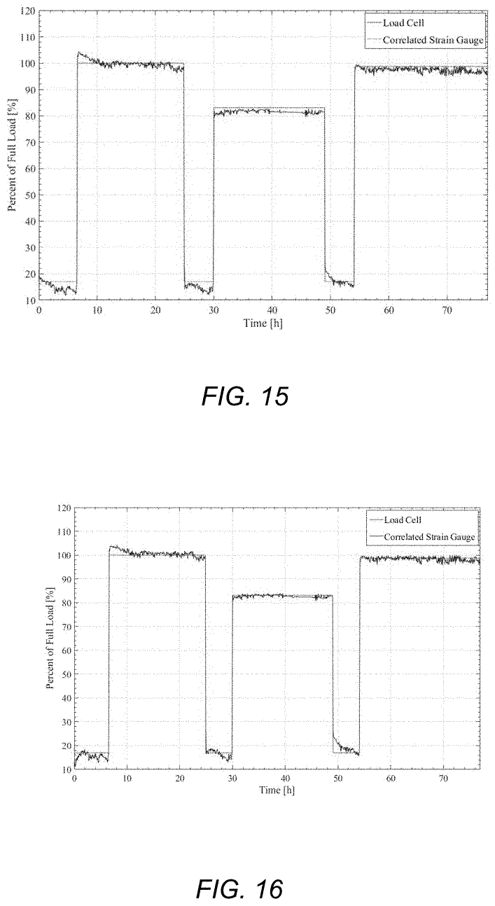

In FIG. 15, the dynamic portion of testing which employs the second-order correlation is presented. The data shows that this method slightly underestimates the load of the bearing with the axle rotating. The correlation had an overall error of 1.65% for the “loaded” portion of the testing, which corresponds to a difference of 2.53 kN (568 lbf) between the load insert strain-gauge measurement and the load-cell reading (used as the reference). The test results applying the multivariate correlation can be seen in FIG. 16. Utilizing multivariate regression analysis, the sensor load measurements match the load-cell readings more closely. The overall average error for the loaded portions of the dynamic test is 1.12%, which corresponds to a 1.71 kN (385 lbf) error in the strain-gauge load measurement.

For both the second order and the multivariate correlations, the sensor overestimates the actual load for a little over three hours at the initial 100% load step. It is speculated that this initial overestimation can be attributed to the loading rate of the system, which results in a high-pressure distribution in the region of the applied load. After several hours have passed, the test rig reaches its steady-state temperature, which allows the sensor accuracy to improve. The sudden load overshoot observed at the initial 100% load step does not occur in the successive loading steps, as can be seen in FIG. 15 and FIG. 16.

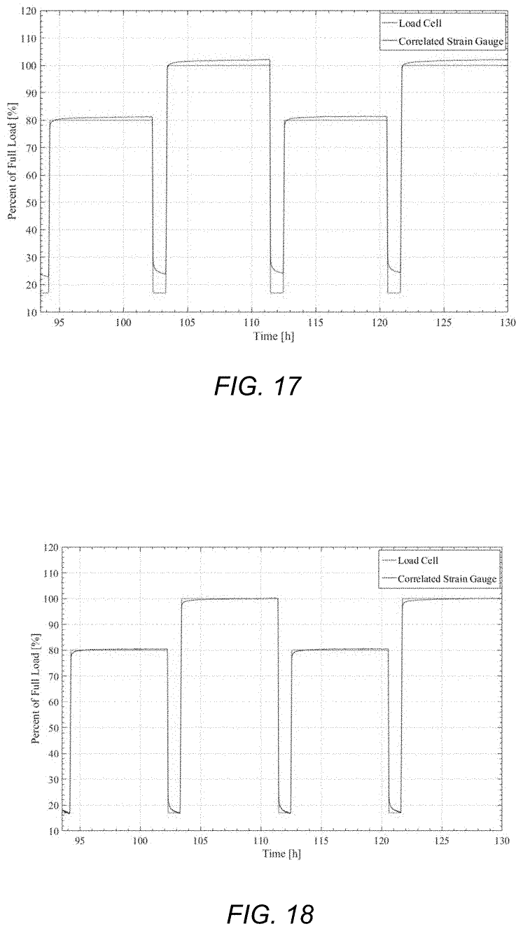

Unlike the dynamic testing results, the second-order calibration for static testing (bearing axle not rotating) tends to overestimate the load on the bearing-adapter assembly. However, the error, seen in FIG. 17, is about 1% for the initial load step. The average error for the entirety of the static testing is around 1.41%, which corresponds to a 2.16 kN (485 lbf) difference in load between the correlated sensor reading and the actual load value.

The average error for the loaded portions of the static testing utilizing the multivariate correlation is merely 0.43%, which corresponds to only 658 N (148 lbf) of freight. The results plotted in FIG. 18 clearly demonstrate that this multivariate correlation more accurately reflects the load seen by the bearing and outperforms the second-order correlation by approximately 1.45% (2.22 kN or 499 lbf) over the static testing period.

When the bearing raceway temperature data was incorporated into the correlation to create the multivariate correlation, the accuracy of the load measurement improved considerably. The error throughout testing for the load sensor was 2.41% when using the second-order correlation. However, when the multivariate regression correlation was implemented, the error decreased to 1.56%, which corresponds to a load disparity of approximately 1,300 N (292 lbf).

Table 3 provides a summary of the results from the testing performed on the load sensor insert. The test parameters listed in the table define how the tests were categorized. The table also displays the calculated average errors corresponding to each portion of the experiment. The error was computed by taking the root-mean-square of the difference between the correlated load sensor readings and the actual load values taken by the load-cell and dividing that difference by the operating full-load of a class K bearing. Therefore, all percent-errors can be multiplied by 153 kN (34.4 kips) to determine the error value in Newtons or (pounds). The load difference (in Newtons and pounds) between the multivariate correlation and the second-order correlation is given in the rightmost column of Table 3. The results for all operating conditions verify that the multivariate correlation is more accurate than the second-order scheme proving that incorporating temperature conditions into the calibration significantly improves the accuracy of the load sensor insert measurements.

TABLE 3
Load sensor measurement optimization test summary
Calculated Average Errors for Various Test Segments

| | Second-Order | Multivariate | Estimated Load |
|---|---|---|---|
| | Correlation | Correlation | Difference |
| Test Parameters | [%] | [%] | [N]/[lbf] |
| All Testing Combined | 2.41 | 1.56 | 1300/292 |
| Dynamic - Fully Loaded | 1.65 | 1.12 | 810/182 |
| Static - Fully Loaded | 1.41 | 0.43 | 1500/337 |
| Dynamic - Unloaded | 1.82 | 1.49 | 507/114 |
| Static - Unloaded | 3.11 | 1.66 | 2220/499 |

It should be noted that all the error calculations were carried out utilizing the load data that was collected five minutes after the load was applied. Any data prior to the five-minute marker is excluded from the error calculations. The latter was done due to the creep behavior of the elastomer pad that requires some settling time after an abrupt large load is applied. The load-sensor insert assembly voltage and temperature data are provided elsewhere.

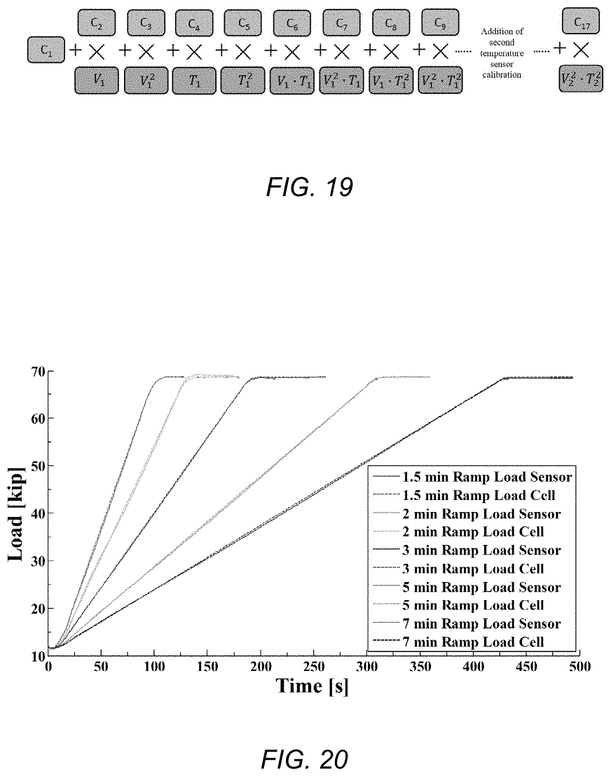

Once it was established that the multivariate correlation was the optimal method for calibrating the load sensor insert, testing was carried out to develop an optimized algorithm that accurately represented the entire load ramping process without the need to ignore the five-minute settling period. In addition, the optimized calibration would account for the effects of ambient conditions. The test rig utilized for this optimized calibration correlation is the four-bearing tester which is housed in an environmental chamber. As stated earlier, the test rig can operate under various ambient conditions allowing for data from two load sensor inserts (i.e., two strain-gauges and four temperature sensors) to be read and recorded simultaneously. The multivariate calibration was carried out following a similar scheme to that shown in FIG. 14. Since more than one device was included, an additional sensor calibration was added to the algorithm, which resulted in more correlation coefficients, as seen in FIG. 19 and Table 4. In FIG. 19, C=Constant Coefficients, V=Load-Sensor Voltage, and T=Temperature. Note that the experiments performed to develop the optimized load sensor insert calibration utilized various load ramping rates as well as a few different operating temperature conditions.

TABLE 4
Optimized calibration coefficients
Optimized Calibration

| | C₂ | C₃ | C₄ | C₅ | C₆ | C₇ | C₈ | C₉ |
|---|---|---|---|---|---|---|---|---|
| C1 | [V₁] | [V₁²] | [T₁] | [T₁²] | [V₁ T₁] | [V₁² · T₁²] | [V₁ · T₁²] | [V₁² · T₁²] |
| | 17891 | 850 | 0 | 12 | −63.6 | −2 | −28 | 0.861 |
| | C₁₀ | C₁₁ | C₁₂ | C₁₃ | C₁₄ | C₁₅ | C₁₆ | C₁₇ |
| [V₀] | [V₂] | [V₂²] | [T₂] | [T₂²] | [V₂ T₂] | [V₂² · T₂²] | [V₂ · T₂²] | [V₂² · T₂²] |
| −4200 | −24516 | 3046 | −693 | 0 | 807 | −10.3 | −119 | 2.15 |

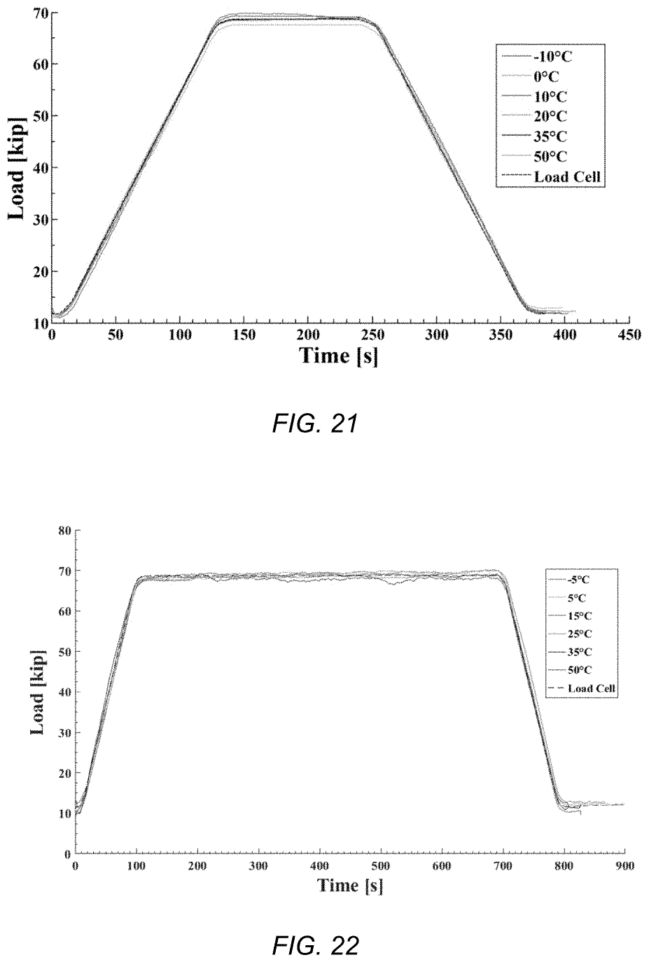

For most static tests at various ambient temperatures, the load sensor produced a steady signal for the different ramping rates. These experiments demonstrated that incorporating temperature into the calibration correlation along with the addition of more coefficients markedly reduced the percent error in loading. Table 5 lists the average percent error for various ambient temperatures at full load. Load ramping occurs from 0 to 306 kN (68.8 kips) on two bearings over the listed time. Results presented in Table 5 show less than 1% error in the load measurements for almost every full-load ramp at the various ambient temperatures. A maximum error of 1.63% was detected for the two-minute ramping test at 0° C., which corresponds to approximately 2.49 kN (560 lbf) on a full-load scale. The various experiments performed can be displayed in graphs like the one shown in FIG. 20, which represents a column from Table 5—the ramp rate testing conducted at 20° C., whereas, FIG. 21 captures the two-minute ramp time for the various ambient temperature conditions—a row on the average percent error table.

TABLE 5

| Ramp Rate | Ramp Time | Calculated Average Percent Error [%] | | | | | |
|---|---|---|---|---|---|---|---|
| [kN/min]/[kips/min] | [min] | −10° C. | 0° C. | 10° C. | 20° C. | 35° C. | 50° C. |
| 102.0/22.9 | 1.5 | 0.09 | 0.37 | 0.17 | 0.18 | 0.21 | 0.15 |
| 76.5/17.2 | 2.0 | 0.88 | 1.63 | 0.69 | 0.22 | 0.18 | 0.29 |
| 51.0/11.5 | 3.0 | 0.27 | 0.57 | 0.33 | 0.19 | 0.20 | 0.12 |
| 30.6/6.9 | 5.0 | 0.17 | 0.59 | 0.58 | 0.14 | 0.34 | 0.09 |
| 21.9/4.9 | 7.0 | 0.19 | 0.35 | 0.05 | 0.17 | 0.54 | 0.11 |

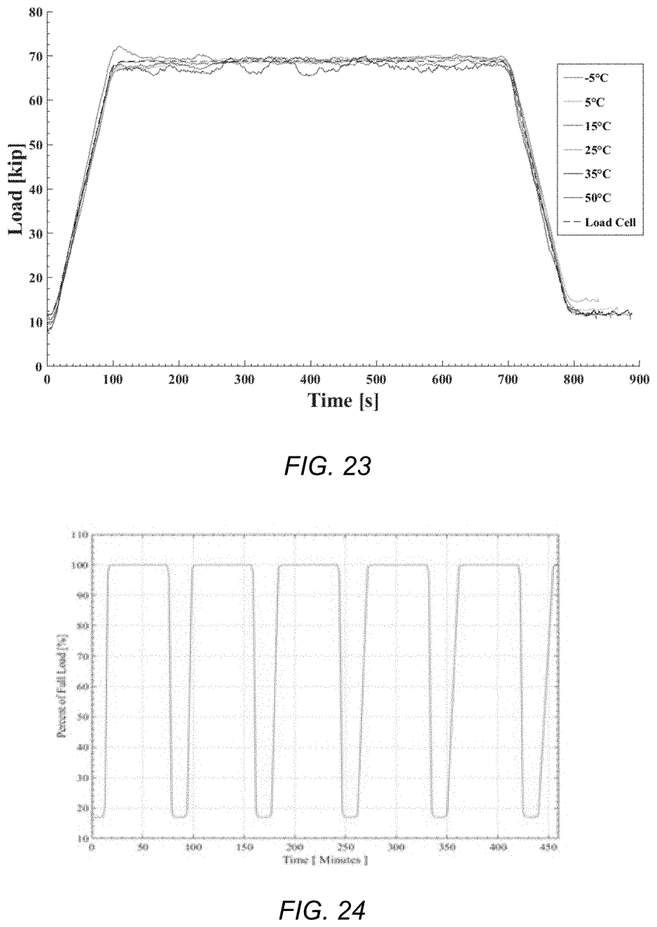

Since the highest percent error occurred at the two-minute-static ramp rate test, the last set of experiments conducted were the two-minute-dynamic load ramps for a test rig with a rotating axle at speeds of 53 km/h (33 mph) and 106 km/h (66 mph) for various ambient temperatures. Table 6 lists the dynamic average percent errors for various ambient temperatures. The results listed in Table 6 indicate that a maximum average error of 2.16% occurred at 106 km/h (66 mph) for an ambient temperature of 35° C., which corresponds to a load of approximately 3.29 kN (740 lbf). The latter load error is the result of the dynamic impacts of the rotating bearing elements that affect the load sensor readings. The sensor calibration is provided in FIG. 22 for the 53 km/h (33 mph) speed; and in FIG. 23 for the 106 km/h (66 mph) speed. Note that, freight cars are usually loaded statically or at very low speeds (10 km/h or 6 mph), so the average percent error data presented here for the dynamic load ramp tests represents a worst-case scenario to demonstrate the accuracy and repeatability of the developed load sensor under different operating conditions.

TABLE 6

| Ambient | | |
|---|---|---|
| Temperature | Average Percent (%) Error | Average Percent (%) Error |
| [° C.] | at 53 km/h (33 mph) | at 106 km/h (66 mph) |
| −5 | 0.85 | 0.61 |
| 5 | 0.37 | 0.61 |
| 15 | 0.64 | 0.96 |
| 25 | 0.97 | 0.73 |
| 35 | 1.25 | 2.16 |
| 50 | 0.37 | 0.78 |

A useful application of the load insert lies in the ability to use this technology alongside railcar loading systems. For this objective to be fulfilled, the sensor may have the ability to readily provide feedback necessary to automate loading and would inevitably have the capability to replace the crude loading systems that are currently in use that employ fill lines to approximate the volume and weight of the railcar system.

The testing process and performance evaluations that follow were preceded by the normal settling period to allow the adapter pad to conform to the stresses imposed by the test rig. The axle was static throughout the testing period except for the duration of the settling period conducted at 25 mph (40 km/h), which is done to properly simulate a railcar loading scenario, in which the cars are either stationary, or in a few exceptional cases moving at an extremely slow velocity.

TABLE 7
Filling Rates (Load per Bearing)

| Relative Loading Time (Unloaded to | | Loading Rate | Loading Rate |
|---|---|---|---|
| Loaded) | | (lbf/min) | (kips/h) |
| 18 | s | 95167 | 5710 |
| 35 | s | 48942 | 2937 |
| 1 | min | 28550 | 1713 |
| 1 min 30 s | | 19033 | 1142 |
| 2 | min | 14275 | 857 |
| 2 min 30 s | | 11420 | 685 |
| 3 | min | 9517 | 571 |
| 3 min 30 s | | 8157 | 489 |
| 4 | min | 7138 | 428 |
| 5 | min | 5710 | 343 |
| 7 | min | 4079 | 245 |
| 10 | min | 2855 | 171 |
| 12 | min | 2379 | 143 |
| 15 | min | 1903 | 114 |

The loading periods were the only portions of testing used to calibrate the sensor. An example of the loading rates as well as the typical testing outline can be seen in Table 7 and FIG. 24. As can be observed, a one hour loaded period occurs after the loading takes place, which is followed by a three-minute unloading period, followed by a 15-minute unloaded period until the next loading rate is applied. This correlation would only be implemented during the actual filling process and would not be utilized for monitoring load after the loading cycle is complete. Different adapters were evaluated through this testing process using a signal conditioning box and a 50 kip (222 kN) rod-end load cell.

The bearing assembly and bearing adapter were at room temperature throughout the majority of the ramping periods. For the following test, it was assumed that the polymer steering pad acts as a solid and does not flow for the duration of loading. Third order correlation was found to be the most suitable correlation choice due to the empirical testing data. The following graphs will demonstrate the accuracy of the load sensor during loading periods while employing a third order voltage correlation. The results will be displayed in a format that exemplifies the relationship between the progressions of the actual load, as observed by the load cell, with the error between the correlated and actual loads with respect to the full load (34,400 lbf or 153 kN). The relationship of the error of the sensor and the actual load are shown for each testing case.

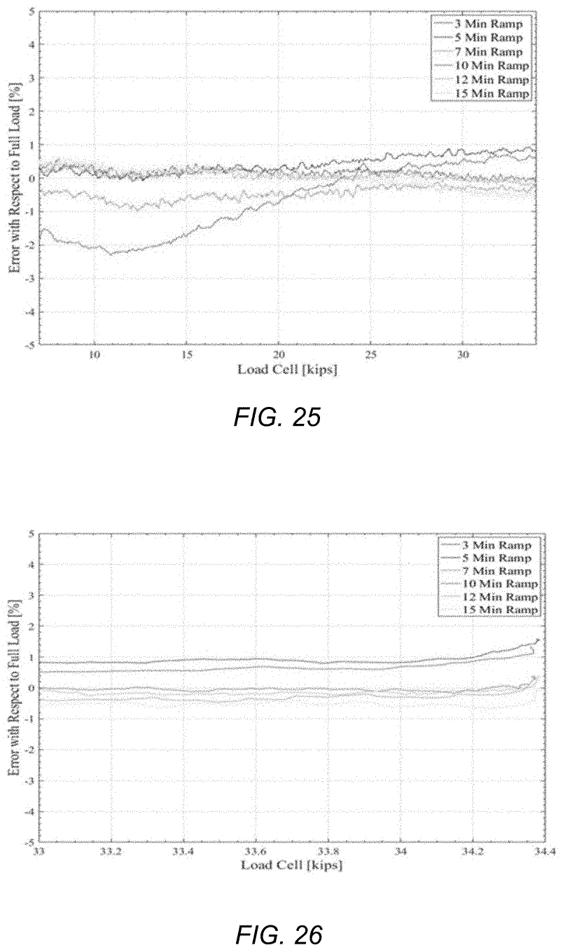

When initially evaluating the implementation of the sensor into loading scenarios, the assumption of a seven-minute loading rate for a grain car was used as a foundation for the initial ramping test conducted with a load-sensor. The test design implements various loading rates to obtain an average third order correlation that can be used for all scenarios. The initial test analyzed loading rates of: 3, 5, 7, 10, 12, and 15 minutes. The results of the first set of testing with a load-sensor are shown in FIG. 25.

FIG. 26 shows the region of FIG. 25 from 33 kips to 34.4 kips (133 kN to 153 kN). The maximum error seen for the correlation was that of the five-minute loading time (1.57%) and the range of error was −0.06% to 1.57%. One interesting observation is that the rates tend to split into two groups based upon the loading rate. One group contains the faster loading rates of three and five minutes, while the slower rates belong to the other group and evidences that creep could play a role in loading rates exceeding five minutes. This test was run twice, where the second test reversed the order of the loading rates to see if this was a factor in the results. Both test periods experienced only a 0.5% maximum difference at the end of the loading periods.

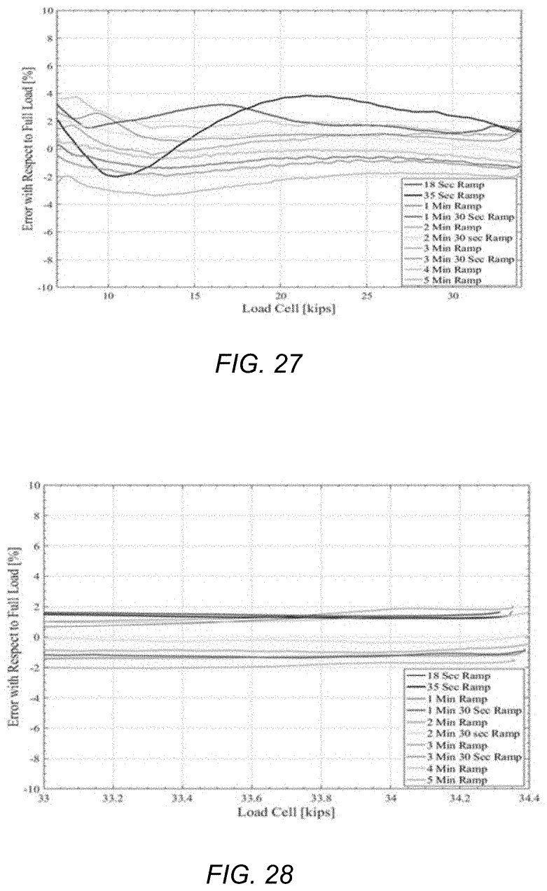

After the initial ramping test was conducted, additional research was done into industries other than that of grain, which proved that the loading rate initially tested was slow compared to the norms of the majority of industries. The fastest rate that was found was 35 seconds to go from an unloaded to a fully loaded state. To include the 35 second loading time into the range of testing, the 18 second loading time was selected as the new starting point of the “fast ramping test.” The five-minute ramp, as the theoretical cutoff point for the creep factor was selected as the slowest rate. The results of the fast ramping test on can be seen in FIG. 27. The zoomed portion of the results of FIG. 27 from 33 kips to 34.4 kips (133 kN to 153 kN) can be seen in FIG. 28. The maximum cutoff error, that when the train is fully loaded, is that of the three-minute ramp, which displayed an error of approximately 1.99% and the range of error was −1.54% to 1.99%.

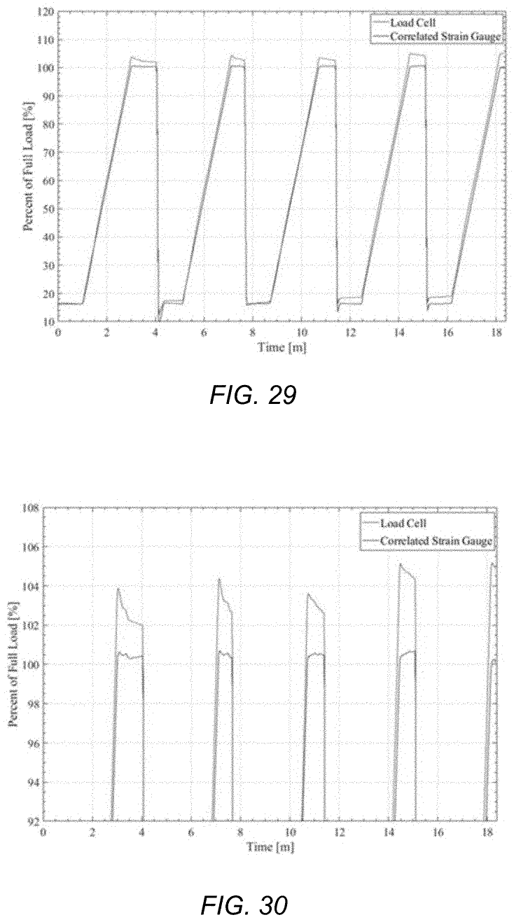

Due to the fairly accurate results from the “ramping” tests, further testing was conducted in which the correlation created from the fast ramping test was employed in an effort to simulate a railcar loading scenario, whereby the sensor would control when the shutoff of the loading system occurs. A program was created using LabVIEW™ which specified a loading rate and used the output of the load sensor to determine when the simulated loading of the railcar would cease. Using the previously calibrated sensor, the test was simulated to run five different ramping rates, from one minute to five minutes. Once the full load according to the sensor was attained, the system would maintain the load according to the sensor for an approximate 90 seconds. Slight variations will therefore be observed in the short periods after the ramping has ceased. FIG. 29 displays the results of the strain-gauge controlled ramping experiment, in which the errors ranged from 3-6%, as demonstrated in FIG. 30.

After initial testing had been conducted, it was important to ensure that the load insert had the structural capabilities necessary to function in the extreme conditions found in the operation of freight railcars. Some of the most structurally compromising events that occur in rail operations are impacts instigated by wheel flats or rail defects. Wheel flats specifically can develop due to imperfections in the wheel geometry, defects present in the material, or stuck handbrakes.

The rail industry has instituted Wheel Impact Load Detectors (WILDs) to measure the approximate force caused by wheel flats to account for this industry-wide issue. Currently, the Association of American Railroads has noted that wheels that have an impact force above 90 kips (400 kN) are faulty wheels, which was the initial target for testing. However, only a consistent 35 kip (160 kN) impact was achieved. While this system will not be able to fully simulate the severest of wheels that are flagged, it does provide data regarding what would be considered a developing wheel flat.

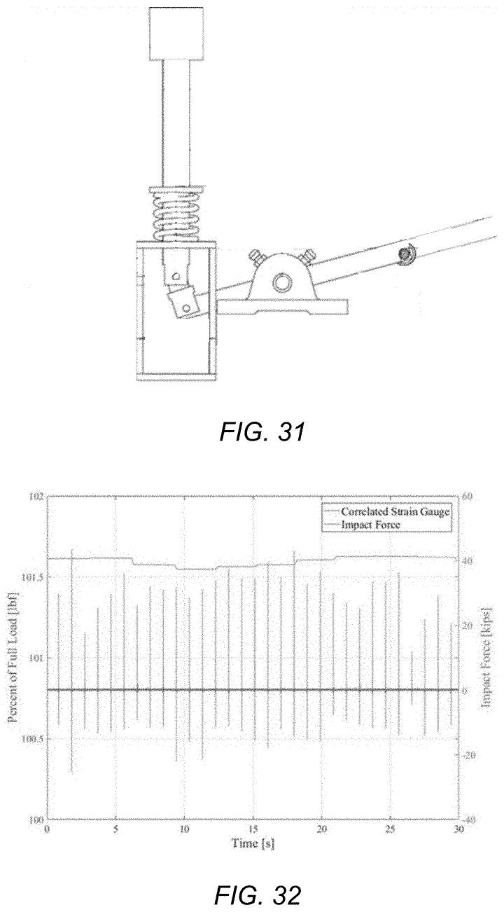

The impact mechanism is depicted in FIG. 31, where a rolling rod that operates on a cam is used to compress a spring of a specified constant to release when the cam reaches the end of its stroke. In order to record the necessary data, an accelerometer was employed that utilized the same data acquisition as that of the load sensor and load cell. The accelerometer, from PCB Piezotronics Inc., was attached to the impact head to measure the acceleration of the mass to derive the impact force imposed by the mechanism. The combined mass of the steel and brass impact head components was 53.37 lb (237 N) and the employed spring had a constant of 200 lb/in (35 kN/m). Data collection for the accelerometer occurred at a sampling rate of 51 kHz to capture the full impact acceleration of the impact head.

In order to analyze the effect of impacts on the load sensor output, the following experiment was conducted. The adapter was held at full-load and operated at 25 mph (40 km/h) while impacts occurred at a frequency slightly above 1 Hz. The results of the test can be observed in FIG. 32, which exhibits the forces that occur due to the impact mechanism and their effect on the correlated output of the load sensor. A maximum force of 44 kips (196 kN) was attained. The correlated output of the sensor is demonstrated to not be affected by the impact of the mechanism. It can be assumed that due to the data collection frequency (50 Hz), the quick variations in the data that result from the impacts are negated. However, further investigations can be conducted which employ a faster data collection frequency and incorporates a spring with a larger constant to determine at what frequency the impacts will affect the sensor. It should be noted that the sensor was unharmed despite the extreme forces applied to the system.

It was discovered, however, that the output received from the data acquisition system after completely unloading the bearing and reloading it to 100% full load would have a voltage difference present which would result in over 5% error post-calibration. This was theorized to be due to a difference in the loaded pressure distribution in the steering pad, where a slight alteration of the position of the component can result in a shift of the effective distribution of stress in the pad. In an effort to improve the precision of the sensor, two mounting methods were evaluated. Mounting the sensor to the bearing adapter was additionally considered a natural progression as the sensor and bearing adapter would most likely be sold as a pair due to the variables involved in the calibration and implementation.

Post-mounting tests were conducted to evaluate the effect the different mounting methods had on the sensor output. This testing was conducted under static conditions over a two-day period. This form of testing was similar to that discussed herein with respect to the static portion of the load accuracy tests, except that the test was shortened to approximately 7.5 hours. After the first day of testing, the adapter was removed from the assembly and allowed to readjust. The testing conducted on the first day was used as the basis for a second-order calibration which was imposed on the output of the second day of testing. The error of the root mean square of the load difference between the correlated and actual load of the second day of testing is taken with respect to the full-load and displayed in the results for each section. The results for the “free floating” sensor can be observed in Table 8 for comparison.

TABLE 8
“Free Floating” Analysis

| Percent of Full-Load | Error |
|---|---|
| (%) | (%) |
| 80 | 5.34 |
| 100 | 4.36 |
| 80 | 4.81 |
| 100 | 5.02 |

The first method considered was mounting the sensor to the bearing adapter by threading holes in which mounting bolts could be attached. Once the machining processes began, however, numerous issues were encountered. The first, but most easily mended, was the sensor housing welds becoming compromised by the reactive forces involved in the milling application, which was due to the inserts being welded previous to the drilling of the mounting positions. This issue resulted in a total reconstruction and positioning of the insert and sensor components. The second and more pressing issue was the effect that using mounting screws had on the data output and its relationship to the load application. The results of the bolt-mounted insert using four mounting bolts can be observed in Table 9, where the results of the testing are shown. The load step errors for the testing are shown in the right column of the table. The high error involved was attributed to the unforeseen bending force applied by the tightening of the mounting bolts on the load sensor, rendering this method of mounting undesirable.

TABLE 9
Bolt-Mounted Analysis

| Percent of Full-Load | Error |
|---|---|
| (%) | (%) |
| 80 | 2.24 |
| 100 | 2.64 |
| 80 | 3.28 |
| 100 | 3.18 |

The next method considered was TIG welding. The sensor casing was welded to the bearing adapter using ER70S-6 welding alloy. During this manufacturing process, all the welds properly formed and besides the presence of surface cracks and the heat involved in the processing, the welding method itself contained no significant drawbacks. An aluminum heat sink was used to resolve the heat of the welding in a process similar to that of the actual construction of the sensor and the surface of the welds were refinished to eliminate any chance of crack propagation. The results of the testing for a TIG weld-mounted insert with four welds is displayed in Table 10. It can be observed that the error of the implemented calibration is much less than that of the bolt-mounted insert. For the bolt-mounted insert, the most severe error was the second 80% step (3.28%). The weld-mounted inserts experienced a maximum error of 3.07%, which occurred on the first 100% step load. The weld-mounting proved to be the best method and benefitted the sensor output. Therefore, adapters utilizing both four and eight welds were created. Shims were additionally implemented in an effort to ensure all the sensors were twelve one-thousandths of an inch (0.305 mm) above the adapter surface.

TABLE 10
Weld-Mounting Analysis

| | Weld Error |
|---|---|
| Percent of Full-Load (%) | (%) |
| 80 | 1.45 |
| 100 | 3.07 |
| 80 | 1.19 |
| 100 | 1.33 |

To further investigate the effect of the extreme forces found in railroad bearing operation that would be imposed on the chosen mounting method, a theoretical fatigue analysis was conducted. Fatigue fractions begin with a minute crack at a local high stress area and the resulting failure results from repeated plastic deformation and occurs over many cycles of yielding often existing at the microscopic level.

The assumptions for the welded material and the loading properties are shown in Table 11. The analysis operated under the assumption that an eighth of the full weight of a railcar utilizing a Class K bearing was distributed evenly across the adapter pad surface, which was assumed to be 4.4 in×7.7 in (112 mm×196 mm). Because we were analyzing the pure shear scenario, which would be the most likely loading scenario to initiate a crack, a friction factor of 0.4 was used, which is an overestimation for most plastic-metal cases. These assumptions equate to a distributed shear stress of 406 psi (2.8 MN/m²), which is incredibly unlikely as the majority of the pressure is typically distributed across the interlocking ridges.

Fatigue analysis additionally makes use of correction coefficients for characteristic properties. The welding material has a yield strength of 65.5 ksi (452 MPa). Each of the welded areas were assumed to be in torsional load cycles and have a “hot rolled” surface. The torsional loading condition was chosen because of the pure shear assumption mentioned previously. According to empirical data, hot rolled surfaces with an ultimate tensile strength of 78 ksi (537 MPa) have a surface factor of approximately 0.65. The load factor for torsion is 0.58 and the gradient factor was assumed to be 0.9.

TABLE 11
Properties and Assumptions for Fatigue Analysis
Material and Loading Properties

| | |
|---|---|
| Ultimate Tensile Strength | 78 ksi |
| Yield Strength | 65.5 ksi |
| Surface | Hot-Rolled |
| Loading | Torsion |

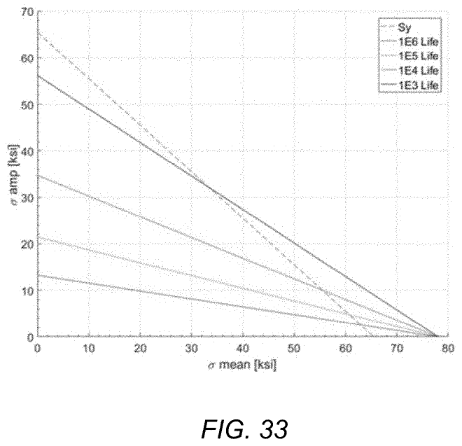

The results of testing are displayed in FIG. 33. The infinite life threshold stress at the designated pressure distribution is 13.2 ksi (91 MPa), which indicates that there is a factor of safety of over 25 for the welded area. According to this model, the welds, if attached properly with no cracks, should not break.

As discussed, the precision of the sensor was questionable as left in its “free floating” assembly. To evaluate the precision of the weld-mounted sensors, tests were designed to demonstrate hypothetical “field employment” scenarios and exhibit the performance of a pre-test calibrated sensor under numerous loading cycles. In the case that a leak or shifting in freight occurs during transportation, small variations in the load would occur. To account for these scenarios, this portion of testing was conducted without the use of the load controller to let the thermal expansion of the hydraulic fluid account for the minimal alterations in load. A load accuracy test was used as the basis of calibration for the tests that follow. The tests performed utilize a control bearing with no noticeable imperfections and a spalled bearing which is used to demonstrate the integrity of the sensor and its signal under the spall-induced vibration. The testing was displayed in weeklong increments to have the resolution necessary to observe the demonstrated trends. All testing employs an adapter fabricated with eight mounting welds. In the following sections, the “loaded” error refers to the “average error” at loads above 90% of full load.

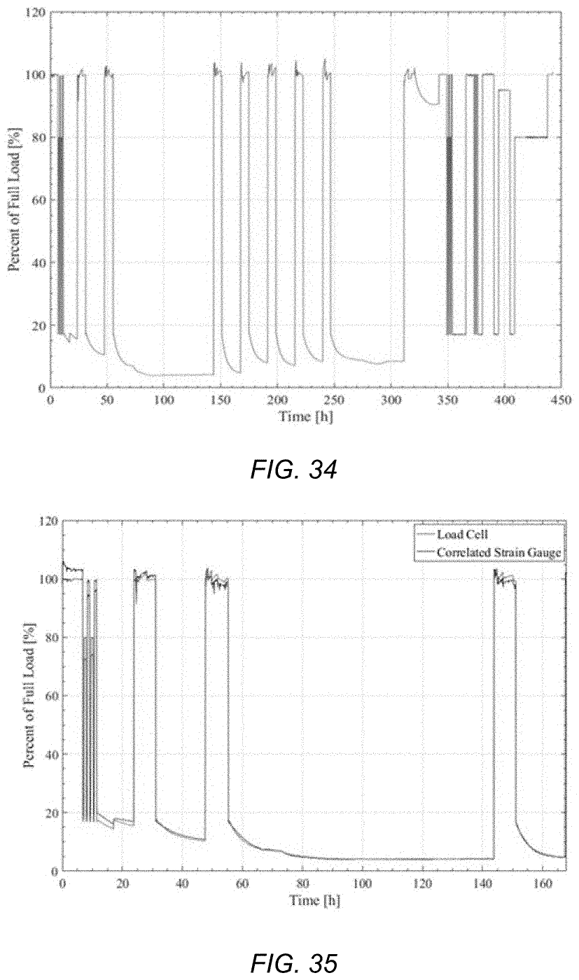

The first set of testing was performed on the test rig using a signal conditioning box and the rod-end load cell. This test utilized a control bearing, focusing solely upon the precision of the welded sensor of the adapter. The three-week test concentrated on loads above 90% of full load with the axle rotating at a speed equivalent to 25 mph (40 km/h). FIG. 34 gives the overview of the three-week test as observed by the load cell.

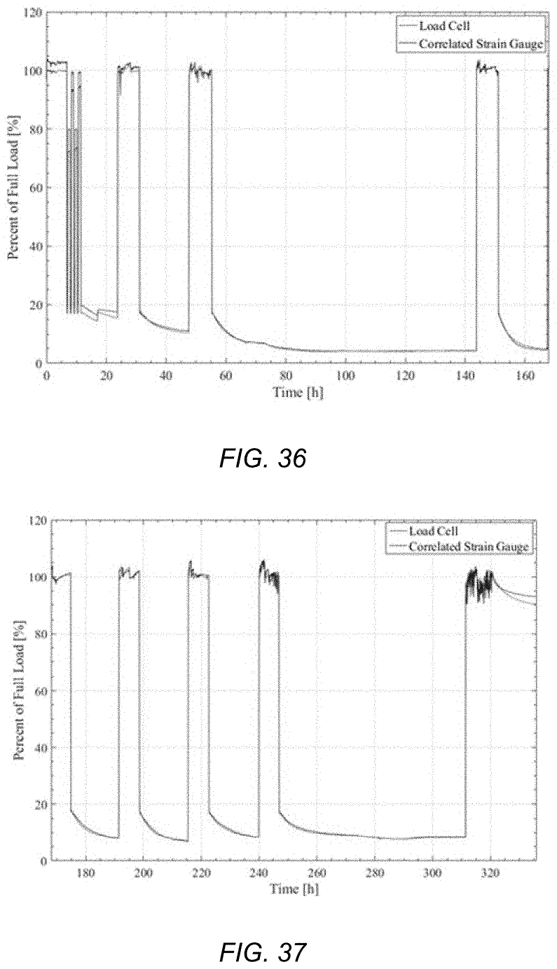

FIG. 35 displays the first week of testing using the second-order correlation. It can be observed at the beginning of testing that the short duration of 80% and 100% alternating static steps displayed a large amount of inaccuracy. The average error for the full week utilizing the second-order correlation, however, was within the desired tolerance at 0.96%. FIG. 36 displays the multivariate counterpart of the test. The average error throughout the first week of testing displayed by the multivariate correlation is 0.98%, however, when evaluating only situations in which the load is above 90% of full-load, the error of the second-order correlation for the first week of testing increases to 2.79% and the multivariate increases to 2.33%. Surprisingly, both sensors were able to accurately reflect the lower loads to a high degree of accuracy.

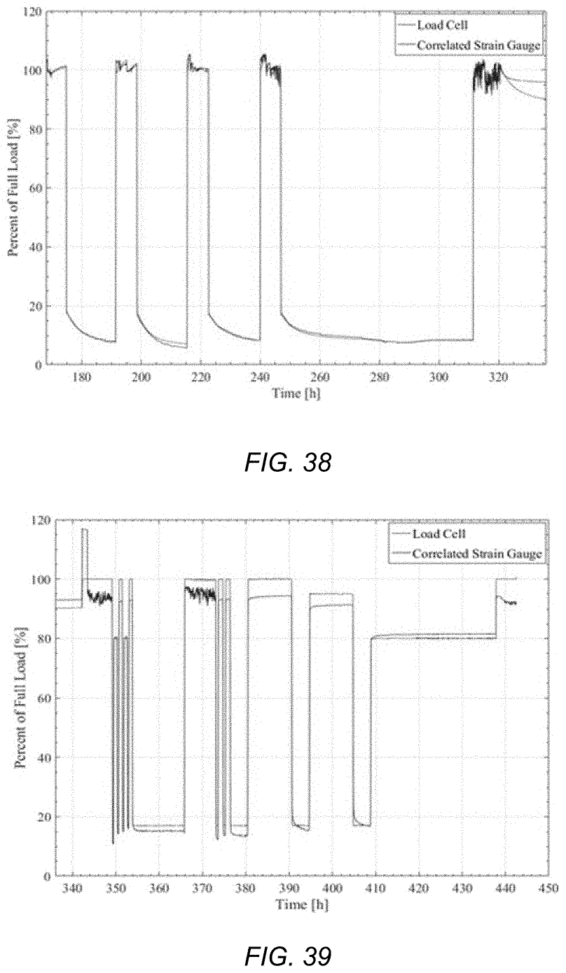

FIG. 37 displays the results of the second week of testing utilizing the second-order correlation method. It can be observed that towards the end of the testing period shown, a significant amount of variation is detected which is additionally found in the multivariate correlation, displayed in FIG. 38, and indicates that the voltage output is the primary cause for the variation. The amount of variation remains approximately the same for both, in which the average error throughout the week testing period is 0.91% for the second-order correlation and 0.87% for the multivariate correlation.

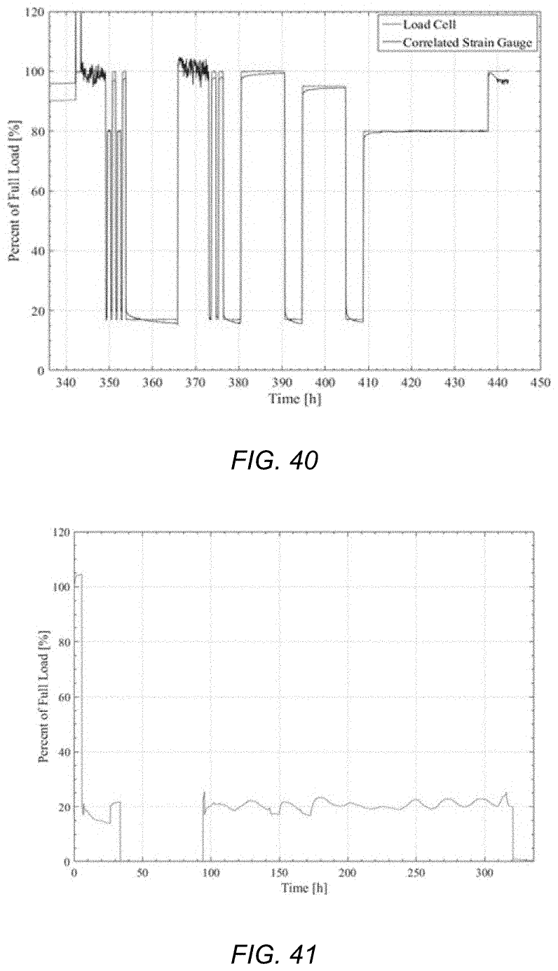

FIG. 39 shows the third week of testing utilizing the second-order correlation, which displayed an average error of 2.94%, which increases to 5.55% when only accounting for test portions exceeding 90% of full-load. Contrastingly, FIG. 40 displays the advantage of the multivariate regression, where the temperature accounted for a large amount of error, decreasing the test period average error to 1.22%.

The set of testing utilizing a spalled bearing was conducted for over a one-month period. The overview of the first set of testing using the spalled bearing can be observed in FIG. 41. As can be seen, this test concentrated on the effect the vibration induced by the spall in an unloaded environment would have on the data output and signal processing. While the inaccuracies are discussed, this was considered to be, primarily, a structural test.

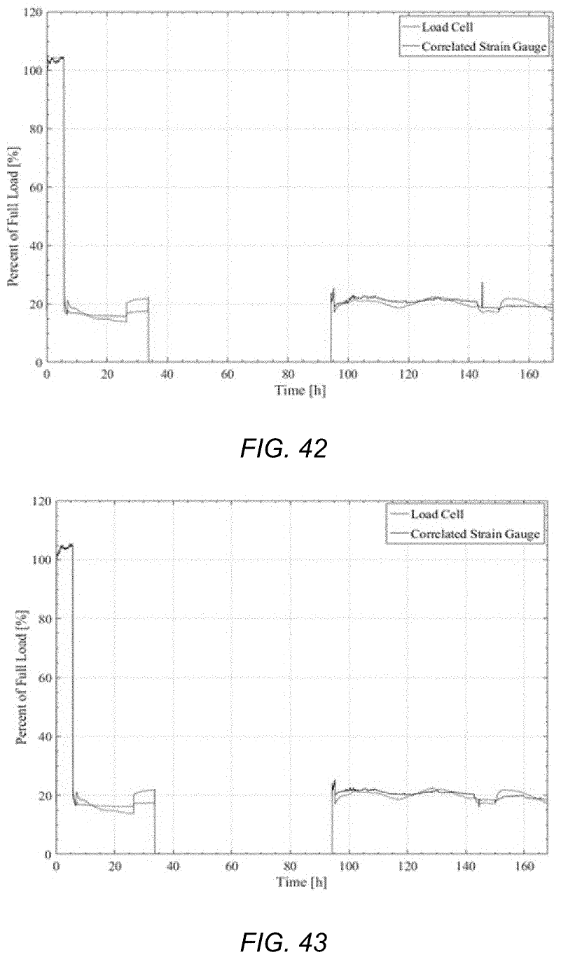

FIG. 42 shows the first week of testing using the second-order correlation, which had an average error of 1.74%. FIG. 43 shows the first week of testing using the multivariate correlation, which had an average of error of 1.65%.

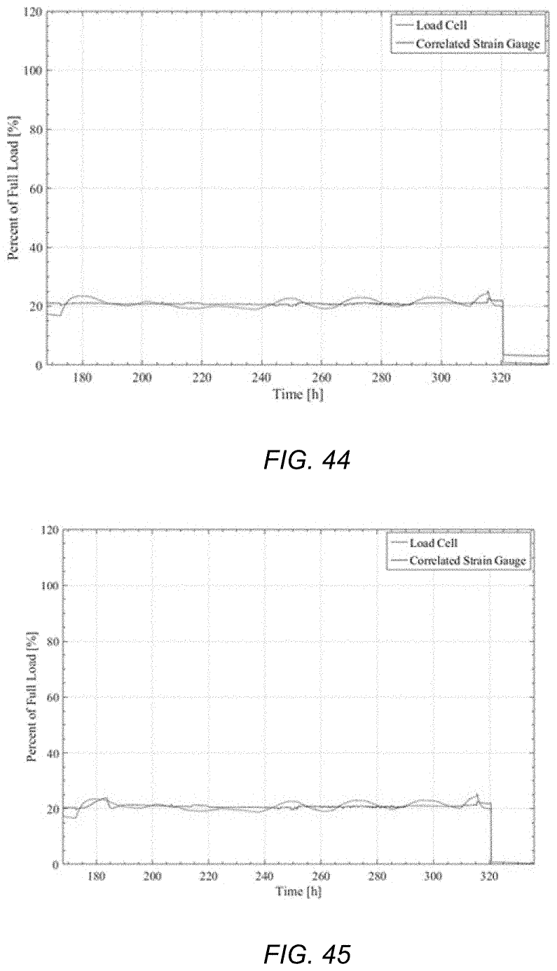

FIG. 44 shows the results of the second week of testing using the second-order correlation, which displayed an average error of 1.35%. FIG. 45 shows the results of the second week of testing utilizing the multivariate correlation, which displayed an average error of 1.31%. It can be observed that both correlations display difficulty in accurately detecting the variations in load, which is primarily attributable to the vibration of the spall and the resulting effect on sensor output. Despite the testing conditions, temperature was able to contribute in some cases which the second-order correlation could not detect, such as the peak that occurs approximately at 180 hours into testing.

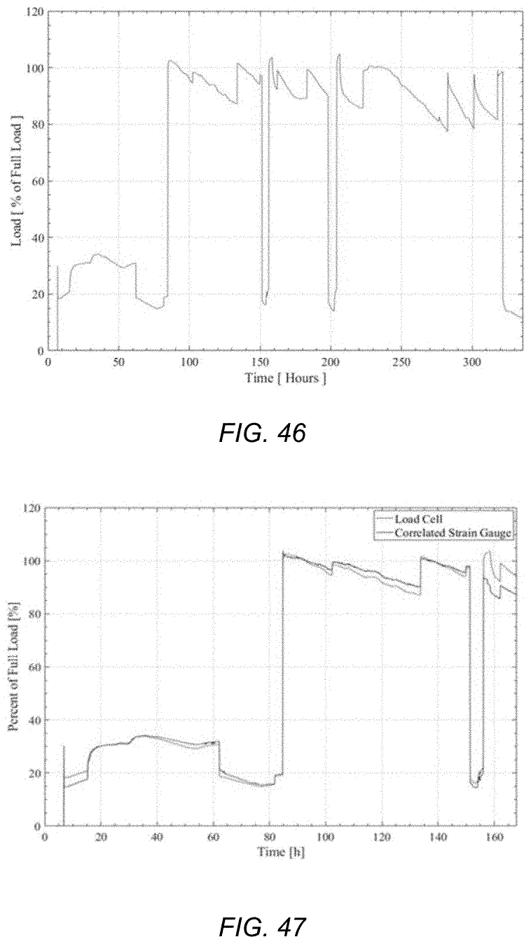

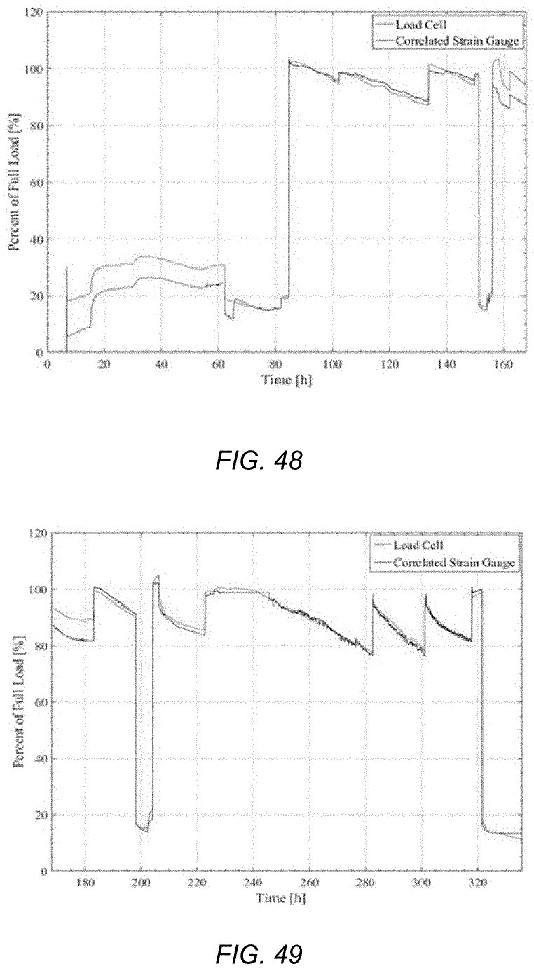

The overview of the second test conducted utilizing a spalled bearing can be seen in FIG. 46. This test focuses on loads above 90% of full load. The first week of testing, utilizing a second-order correlation, can be observed in FIG. 47. It can be seen that half of the first week was attributed to the continuation of the unloaded vibration testing seen previously, however, the second half concentrates on loaded situations. The second order correlation displayed an average error of 2.70% for the first week of testing, while the multivariate regression method, seen in FIG. 48, displayed an average error of 5.49% which was due to the inability of the correlation to account for the unloaded portion at the beginning of testing. The error of the multivariate correlation decreases slightly when evaluating only loaded situations, where the loaded error of the second-order correlation decreases to 3.36%. Contrastingly, the loaded error of the second-order correlation increases to 3.67%. These averages, however, incorporate an outlier, as it seems that a fast reloading of the system at approximately 155 hours into testing affected the pressure distribution of the steering pad. In application, railcars are typically not loaded in under 20 seconds, therefore, the actual average errors for the testing period would decrease to 1.68% for the second-order method and 1.23% for the multivariate method.

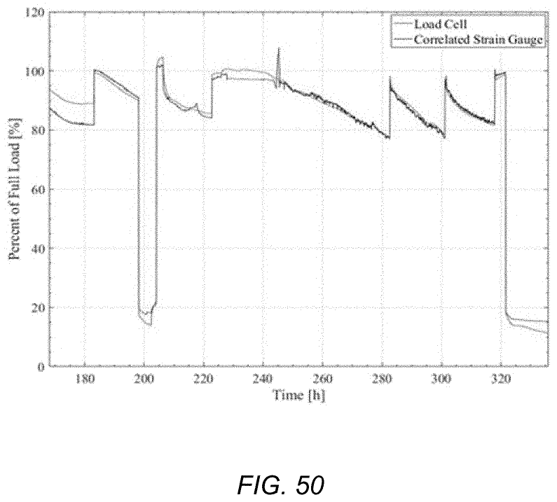

FIG. 49 shows the second week of testing utilizing the second-order correlation which displayed an average error of 3.27%. FIG. 50 shows the second week of testing utilizing the multivariate correlation, which displayed an average error of 4.27%. However, when analyzing only the loaded portions of testing, the error of the second-order correlation increased to 3.55% and the error of the multivariate correlation increased to 4.63%.

The summary of errors present in the reliability testing performed on an adapter can be observed in Table 12. It can be seen that for the first test utilizing the spalled bearing, there are no loaded errors given which is due to the limited amount of data within the testing period above 90% of full load. In two of the week testing periods, the second-order correlation outperforms the multivariate in the loaded case. This could be attributable to the amount of data points used to average the data and the instabilities that could arise from the multiple parameters involved in the post-processing of the multivariate correlation. It should also be noted that the welds and sensor went undamaged throughout this long and arduous testing period.

TABLE 12
Reliability Test Error Summary
Control Bearing

| | Week 1 | Week2 | Week 3 |
|---|---|---|---|
| 2^{nd} Order (%) | 0.96 | 0.91 | 2.94 |
| Multivariate (%) | 0.98 | 0.87 | 1.22 |
| 2^{nd} Order Loaded (%) | 2.79 | 2.34 | 5.55 |
| Multivariate Loaded (%) | 2.33 | 2.11 | 2.41 |

| | |
|---|---|
| Week 1 | Week 2 |

Spalled Bearing Test 1

| | | |
|---|---|---|
| 2^{nd} Order (%) | 1.74 | 1.35 |
| Multivariate (%) | 1.65 | 1.31 |

Spalled Bearing Test 2

| | | |
|---|---|---|
| 2^{nd} Order (%) | 2.70 | 3.27 |
| Multivariate (%) | 5.49 | 4.27 |
| 2^{nd} Order Loaded (%) | 3.67 | 3.55 |
| Multivariate Loaded (%) | 3.36 | 4.63 |

Currently, the railroad industry utilizes weighbridges at special sections of track to measure the load of freight cars. These weighbridges are found in railyards and freight loading stations and are not commonly present along the 140,000 rail miles operated by the U.S. railroad companies. Thus, once the freight car leaves the railyard, it is not possible for the operator to continuously track the railcar load, which is especially important for railcars carrying hazardous material.

To this end, an onboard load sensor that can accurately and reliably track the load was developed and validated in the laboratory through carefully designed experiments that mimic field service conditions. The load sensor is strain-gage-based and is encapsulated within a steel insert that sits just below the polymer adapter pad on a groove on top of the steel bearing adapter. Eight of these load sensor inserts are used on one freight car to determine the total weight of the railcar. Furthermore, each load sensor insert is equipped with two temperature sensors that measure the bearing operating temperature at both outer ring (cup) raceways. Hence, other than accurately tracking the weight of a railcar, the load sensor insert is also capable of identifying any abnormal operation conditions caused by load shifting within the freight car or unusual bearing operating temperatures.

Two methods of calibration were examined: a second-order method and a multivariate regression method. Several testing scenarios were carried out which produced repeatable and optimized results. The incorporation of raceway temperatures into the calibration algorithm of the load sensor insert allows for improved accuracy in the estimation of the load applied on the bearing adapter. The average percent error in the load readings for a stationary or moving fully loaded railcar was within 1%, which is remarkable considering the nonlinear creep behavior of the polymer steering pads. In some embodiments, a wireless battery-powered version of the load-sensor insert, may be more suitable for long-term rail service.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes ma be reversed, and certain features of the invention may be utilized independently, all as would be apparent to one skilled in the art after having the benefit of this description of the invention. Changes may, be made in the elements described herein without departing from the spirit and scope of the invention as described in the following claims.

1. A load sensor device for a railcar comprising:
a casing;
one or more strain gauges and one or more temperature sensors disposed in the casing; and
a processor coupled to the one or more strain gauges and the one or more temperature sensors, wherein the processor collects data obtained by the one or more strain gauges and the one or more temperature sensors;
wherein the casing has a shape and size configured to be embedded in a bearing adapter of the railcar.

2. The load sensor of claim 1, wherein at least one of the one or more strain gauges is capable of measuring an applied load of between about 10 kN to about 200 kN.

3. The load sensor of claim 1, wherein at least one of the one or more temperature sensors is capable of measuring temperatures ranging from about −40 C to about 150 C.

4. The load sensor of claim 1, wherein openings are formed in the casing at the position of each of the one or more temperature sensors.

5. The load sensor of claim 1, further comprising a line driver coupled to the one or more strain gauges and the one or more temperature sensors configured to amplify the data obtained from the one or more strain sensors and the one or more temperature sensors.

6. A system for determining the mass of a railcar comprising:
one or more load sensor device(s) positioned on a bearing adapter of a railcar comprising:
a casing;
one or more strain gauges and one or more temperature sensors disposed in the casing; and
a processor coupled to the one or more strain gauges and the one or more temperature sensors, wherein the processor collects data obtained by the one or more strain gauges and the one or more temperature sensors;
wherein the casing has a shape and size configured to be embedded in a bearing adapter of the railcar; and
a control box, wherein the control box is positioned inside the railcar, and wherein the control box is coupled to the one or more load sensor devices.

7. The system of claim 6, wherein the control box comprises a signal conditioner.

8. The system of claim 6, wherein the control box is coupled to the one or more load sensors through a wireless connection.

9. The system of claim 6, wherein the control box comprises one or more processors configured to perform signal conditioning of signals received from the load sensor device.

10. The system of claim 6, wherein at least one of the one or more strain gauges is capable of measuring an applied load of between about 10 kN to about 200 kN.

11. The system of claim 6, wherein at least one of the one or more temperature sensors is capable of measuring temperatures ranging from about −40 C to about 150 C.

12. The system of claim 6, wherein the load sensor device further comprising a line driver coupled to the one or more strain gauges and the one or more temperature sensors configured to amplify the data obtained from the one or more strain sensors and the one or more temperature sensors before the data is sent to the control box.

13. The system of claim 6, wherein the load sensor device is placed on a top surface of the bearing adapter.

14-22. (canceled)

23. A bearing adapter for a railcar, the bearing adapter comprising:
a body having a substantially planar top surface, an arced bottom surface, and sidewalls connecting the top surface to the bottom surface, wherein the top surface receives a portion of a railcar side frame during use, and wherein the arced bottom surface rests on a portion of a bearing assembly during use; and
a load sensor device, at least partially embedded in a surface of the body, the load sensor device comprising;
a casing;
one or more strain gauges and one or more temperature sensors disposed in the casing; and
a processor coupled to the one or more strain gauges and the one or more temperature sensors, wherein the processor collects data obtained by the one or more strain gauges and the one or more temperature sensors;

24. The bearing adapter of claim 23, wherein the load sensor device is positioned on the top surface of the body.

25. The bearing adapter of claim 23, wherein at least one of the one or more strain gauges is capable of measuring an applied load of between about 10 kN to about 200 kN.

26. The bearing adapter of claim 23, wherein at least one of the one or more temperature sensors is capable of measuring temperatures ranging from about −40 C to about 150 C.

27. The bearing adapter of claim 23, wherein openings are formed in the casing at the position of each of the one or more temperature sensors such that, when the load sensing device is coupled to the bearing adapter, the side of the casing having openings is in contact with the top surface of the body.

28. The bearing adapter of claim 23, further comprising a line driver coupled to the one or more strain gauges and the one or more temperature sensors configured to amplify the data obtained from the one or more strain sensors and the one or more temperature sensors.

29. The bearing adapter of claim 23, wherein the casing extends above the top surface of the body.
